(19) United States
(12) Patent Application Publication
(10) Pub. No.: US 2026/0094351 A1
(43) Pub. Date: Apr. 2, 2026

(54) UPDATING VIRTUAL SPATIAL ARRANGEMENTS OF USERS IN MULTI-USER COMMUNICATION SESSIONS

(71) Applicant: Apple Inc., Cupertino, CA (US)

(72) Inventors: Connor A. SMITH, San Jose, CA (US); Kevin LEE, San Jose, CA (US); Emily Lynn CHEN, San Francisco, CA (US); Anish KANNAN, Sunnyvale, CA (US); Willem MATTELAER, San Jose, CA (US)

(21) Appl. No.: 19/310,478

(22) Filed: Aug. 26, 2025

Related U.S. Application Data
(60) Provisional application No. 63/700,351, filed on Sep. 27, 2024.

(51) Int. Cl. G06T 15/10; G06T 19/00

(52) U.S. Cl. CPC G06T 15/10; G06T 19/00; G06T 2219/024

(57) ABSTRACT

In some examples, an electronic device facilitates updating a virtual seating assignment in response to detecting inputs requesting swapping of virtual seats. In some examples, an electronic device facilitates reassigning of users to updated virtual seats within a virtual seating assignment. In some examples, the reassigning is automatically performed after a user interacts with a three-dimensional environment and/or a virtual seat.

### CROSS REFERENCE TO RELATED APPLICATIONS

This application claims the benefit of U.S. Provisional Application No. 63/700,351, filed Sep. 27, 2024, the entire disclosure of which is herein incorporated by reference for all purposes.

### FIELD OF THE DISCLOSURE

This relates generally to systems and methods of managing and updating virtual spatial arrangements of users of electronic devices in three-dimensional environments within multi-user communication sessions that include the electronic devices.

### BACKGROUND OF THE DISCLOSURE

Some computer graphical environments provide two-dimensional and/or three-dimensional environments where at least some objects displayed for a user's viewing are virtual and generated by a computer. In some examples, three-dimensional environments are presented by multiple electronic devices in communication with each other. In some examples, users associated with the multiple electronic devices in communication with each other are arranged according to virtual spatial arrangements in three-dimensional environments.

### SUMMARY OF THE DISCLOSURE

Some examples of the disclosure are directed to systems and methods for updating virtual seating arrangements in accordance with user input. In some examples, a method is performed at a first electronic device in communication with one or more input devices and one or more displays. In some examples, while the first electronic device corresponding to a first user is in a multi-user communication session with one or more electronic devices including a second electronic device, different from the first electronic device, corresponding to a second user, the first electronic device presents a three-dimensional environment from a first viewpoint of the first electronic device corresponding to a first location of the three-dimensional environment, including presenting, via the one or more displays, a representation of the second user at a second location, different from the first location, of the three-dimensional environment. In some examples, while presenting the representation of the second user at the second location, the first electronic device detects, via the one or more input devices, one or more inputs including a request to change from the first viewpoint of the first electronic device to a second viewpoint of the first electronic device. In some examples, in response to detecting the one or more inputs, and in accordance with a determination that one or more first criteria are satisfied including a criterion that is satisfied when the one or more inputs are directed toward the second location, the first electronic device presents, via the one or more displays, the three-dimensional environment from the second viewpoint of the first electronic device to correspond to the second location in the three-dimensional environment. In some examples, the first electronic device presents, via the one or more displays, the representation of the second user at the first location in the three-dimensional environment.

Some examples of the disclosure are directed to systems and methods for reassigning virtual seats. In some examples, a method is performed at a first electronic device in communication with one or more input devices and one or more displays. In some examples, while the first electronic device corresponding to a first user is in a multi-user communication session with one or more electronic devices including a second electronic device, different from the first electronic device, corresponding to a second user, the first electronic device presents, via the one or more displays, a three-dimensional environment in accordance with a virtual seating arrangement for a plurality of participants of the multi-user communication session, wherein the virtual seating arrangement includes a first virtual seat assigned to the first user and a second virtual seat, different from the first virtual seat, assigned to the second user. In some examples, while presenting the three-dimensional environment in accordance with the virtual seating arrangement in the multi-user communication session, the first electronic device detects an interaction of the first user. In some examples, after detecting the interaction, and in accordance with a determination that one or more criteria are satisfied, including a criterion that is satisfied when the interaction of the first user with the three-dimensional environment corresponds to a virtual seat in the virtual seating arrangement other than the first virtual seat, the first electronic device reassigns the first user from the first virtual seat to the virtual seat other than the first virtual seat. In some examples, while the first electronic device is in the multi-user communication session, the first electronic device detects, via the one or more input devices, one or more first inputs. In some examples, in response to detecting the one or more first inputs, the first electronic device updates display of virtual content in the three-dimensional environment, including a representation of the second user, relative to a viewpoint of the first electronic device based on the virtual seating arrangement, including: in accordance with a determination that the first user is assigned to the first virtual seat, displaying the virtual content in the three-dimensional environment relative to the viewpoint of the first electronic device with a first spatial arrangement; and in accordance with a determination that the first user is reassigned to the virtual seat other than the first virtual seat, displaying the virtual content in the three-dimensional environment relative to the viewpoint of the first electronic device with a second spatial arrangement, different from the first spatial arrangement.

The full descriptions of these examples are provided in the Drawings and the Detailed Description, and it is understood that this Summary does not limit the scope of the disclosure in any way.

### BRIEF DESCRIPTION OF THE DRAWINGS

For improved understanding of the various examples described herein, reference should be made to the Detailed Description below along with the following drawings. Like reference numerals often refer to corresponding parts throughout the drawings.

FIG. 1 illustrates an electronic device presenting an extended reality environment according to some examples of the disclosure.

FIGS. 2A-2B illustrate block diagrams of example architectures for electronic devices or systems according to some examples of the disclosure.

FIGS. 3A-3N illustrate an example of updating a virtual seating arrangement according to some examples of the disclosure.

FIGS. 4A-4L illustrate example approaches for reassigning virtual seats according to some examples of the disclosure.

FIG. 5 illustrates a flow diagram illustrating an example process for updating a virtual seating arrangement according to some examples of the disclosure.

FIG. 6 illustrates a flow diagram illustrating an example process for reassigning virtual seats according to some examples of the disclosure.

### DETAILED DESCRIPTION

Some examples of the disclosure are directed to systems and methods for updating virtual seating arrangements in accordance with user input. In some examples, a method is performed at a first electronic device in communication with one or more input devices and one or more displays. In some examples, while the first electronic device corresponding to a first user is in a multi-user communication session with one or more electronic devices including a second electronic device, different from the first electronic device, corresponding to a second user, the first electronic device presents a three-dimensional environment from a first viewpoint of the first electronic device corresponding to a first location of the three-dimensional environment, including presenting, via the one or more displays, a representation of the second user at a second location, different from the first location, of the three-dimensional environment. In some examples, while presenting the representation of the second user at the second location, the first electronic device detects, via the one or more input devices, one or more inputs including a request to change from the first viewpoint of the first electronic device to a second viewpoint of the first electronic device. In some examples, in response to detecting the one or more inputs, and in accordance with a determination that one or more first criteria are satisfied including a criterion that is satisfied when the one or more inputs are directed toward the second location, the first electronic device presents, via the one or more displays, the three-dimensional environment from the second viewpoint of the first electronic device to correspond to the second location in the three-dimensional environment. In some examples, the first electronic device presents, via the one or more displays, the representation of the second user at the first location in the three-dimensional environment.

Some examples of the disclosure are directed to systems and methods for reassigning virtual seats. In some examples, a method is performed at a first electronic device in communication with one or more input devices and one or more displays. In some examples, while the first electronic device corresponding to a first user is in a multi-user communication session with one or more electronic devices including a second electronic device, different from the first electronic device, corresponding to a second user, the first electronic device presents, via the one or more displays, a three-dimensional environment in accordance with a virtual seating arrangement for a plurality of participants of the multi-user communication session, wherein the virtual seating arrangement includes a first virtual seat assigned to the first user and a second virtual seat, different from the first virtual seat, assigned to the second user. In some examples, while presenting the three-dimensional environment in accordance with the virtual seating arrangement in the multi-user communication session, the first electronic device detects an interaction of the first user. In some examples, after detecting the interaction, and in accordance with a determination that one or more criteria are satisfied, including a criterion that is satisfied when the interaction of the first user with the three-dimensional environment corresponds to a virtual seat in the virtual seating arrangement other than the first virtual seat, the first electronic device reassigns the first user from the first virtual seat to the virtual seat other than the first virtual seat. In some examples, while the first electronic device is in the multi-user communication session, the first electronic device detects, via the one or more input devices, one or more first inputs. In some examples, in response to detecting the one or more first inputs, the first electronic device updates display of virtual content in the three-dimensional environment, including a representation of the second user, relative to a viewpoint of the first electronic device based on the virtual seating arrangement, including: in accordance with a determination that the first user is assigned to the first virtual seat, displaying the virtual content in the three-dimensional environment relative to the viewpoint of the first electronic device with a first spatial arrangement; and in accordance with a determination that the first user is reassigned to the virtual seat other than the first virtual seat, displaying the virtual content in the three-dimensional environment relative to the viewpoint of the first electronic device with a second spatial arrangement, different from the first spatial arrangement.

In some examples, a spatial group or state in the multi-user communication session denotes a spatial arrangement or template that dictates locations of users and content that are located in or otherwise associated with the spatial group. As used herein, a spatial group corresponds to a group or number of participants (e.g., users) in a multi-user communication session. In some examples, a spatial group in the multi-user communication session has a spatial arrangement that dictates locations of users and content that are located in the spatial group. In some examples, users in the same spatial group within the multi-user communication session experience spatial truth according to the spatial arrangement of the spatial group. In some examples, when the user of the first electronic device is in a first spatial group and the user of the second electronic device is in a second spatial group in the multi-user communication session, the users experience spatial truth that is localized to their respective spatial groups. In some examples, while the user of the first electronic device and the user of the second electronic device are grouped into separate spatial groups within the multi-user communication session, if the first electronic device and the second electronic device return to the same operating state, the user of the first electronic device and the user of the second electronic device are regrouped into the same spatial group within the multi-user communication session.

As used herein, a hybrid spatial group corresponds to a group or number of participants (e.g., users) in a multi-user communication session in which at least a subset of the participants is non-collocated in a physical environment. For example, as described via one or more examples in this disclosure, a hybrid spatial group includes at least two participants who are collocated in a first physical environment and at least one participant who is non-collocated with the at least two participants in the first physical environment (e.g., the at least one participant is located in a second physical environment, different from the first physical environment). In some examples, a hybrid spatial group in the multi-user communication session has a spatial arrangement that dictates locations of users and content that are located in the spatial group. In some examples, users in the same hybrid spatial group within the multi-user communication session experience spatial truth according to the spatial arrangement of the spatial group, as similarly discussed above.

In some examples, managing a virtual spatial arrangement of a plurality of users in a multi-user communication session may include interaction with one or more user interface elements. In some examples, a user's gaze may be tracked by an electronic device as an input for targeting a selectable option/affordance within a respective user interface element that is displayed in the three-dimensional environment. For example, gaze can be used to identify one or more options/affordances targeted for selection using another selection input. In some examples, a respective option/affordance may be selected using hand-tracking input detected via an input device in communication with the electronic device. In some examples, objects displayed in the three-dimensional environment may be moved and/or reoriented in the three-dimensional environment in accordance with movement input detected via the input device.

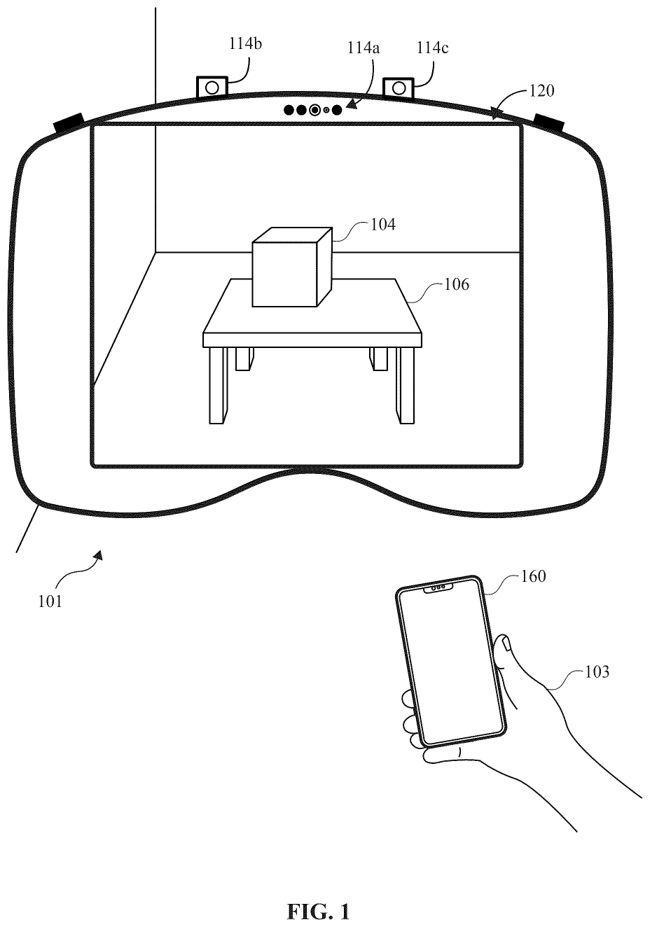

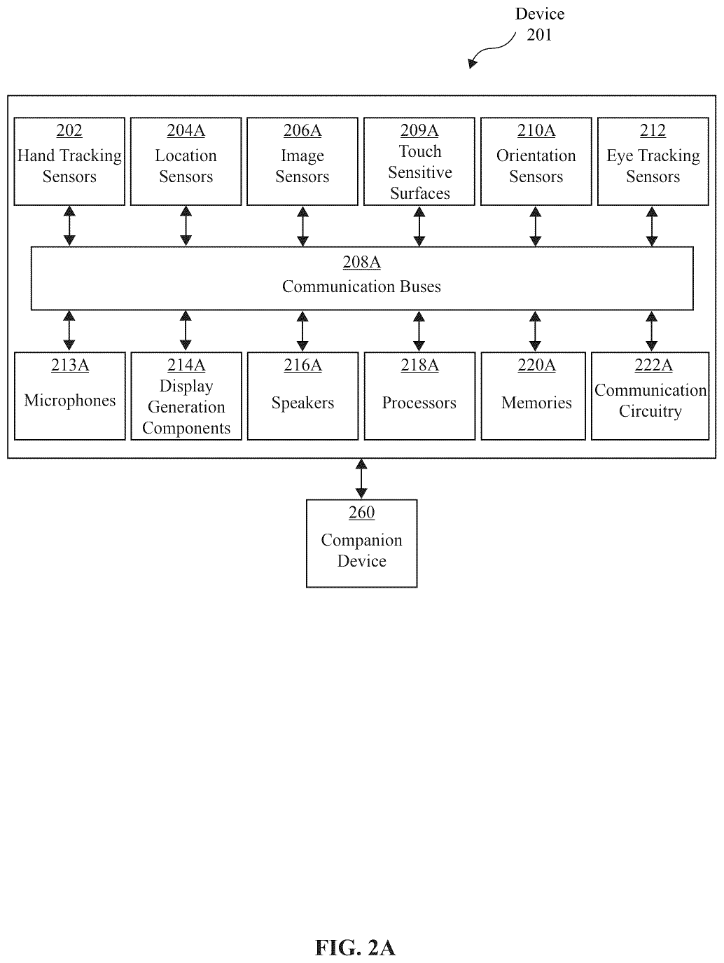

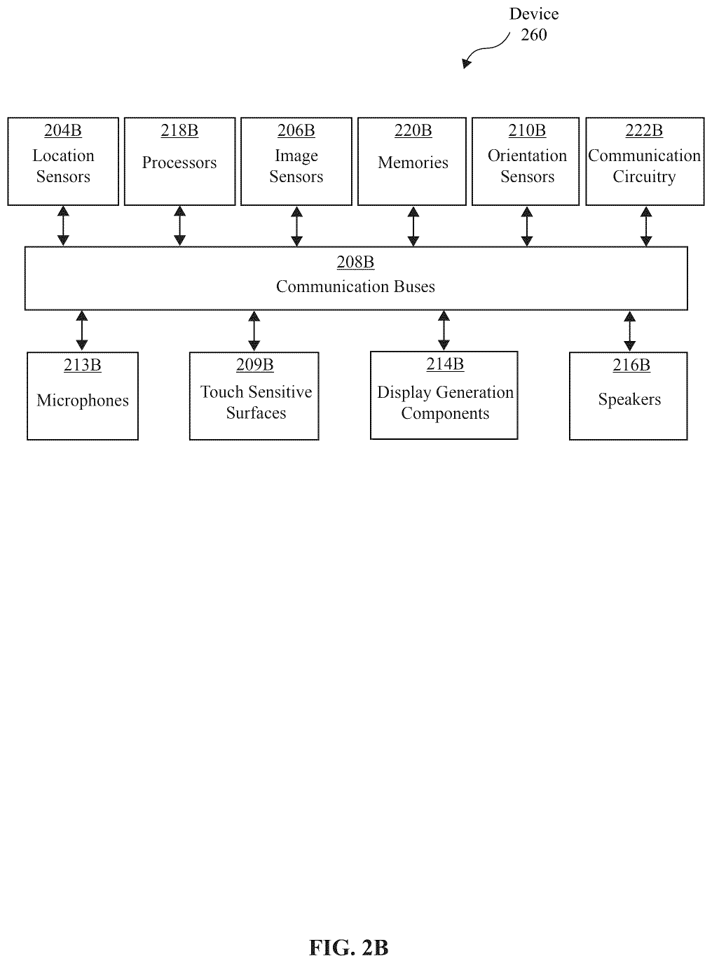

FIG. 1 illustrates an electronic device 101 presenting three-dimensional environment (e.g., an extended reality (XR) environment or a computer-generated reality (CGR) environment, optionally including representations of physical and/or virtual objects), according to some examples of the disclosure. In some examples, as shown in FIG. 1, electronic device 101 is a head-mounted display or other head-mountable device configured to be worn on a head of a user of the electronic device 101. Examples of electronic device 101 are described below with reference to the architecture block diagram of FIG. 2A. As shown in FIG. 1, electronic device 101 and table 106 are located in a physical environment. The physical environment may include physical features such as a physical surface (e.g., floor, walls) or a physical object (e.g., table, lamp, etc.). In some examples, electronic device 101 may be configured to detect and/or capture images of the physical environment including table 106 (illustrated in the field of view of electronic device 101).

In some examples, as shown in FIG. 1, electronic device 101 includes one or more internal image sensors 114a oriented towards a face of the user (e.g., eye tracking cameras as described below with reference to FIGS. 2A-2B). In some examples, internal image sensors 114a are used for eye tracking (e.g., detecting a gaze of the user). Internal image sensors 114a are optionally arranged on the left and right portions of display 120 to enable eye tracking of the user's left and right eyes. In some examples, electronic device 101 also includes external image sensors 114b and 114c facing outwards from the user to detect and/or capture the physical environment of the electronic device 101 and/or movements of the user's hands or other body parts.

In some examples, display 120 has a field of view visible to the user. In some examples, the field of view visible to the user is the same as a field of view of external image sensors 114b and 114c. For example, when display 120 is optionally part of a head-mounted device, the field of view of display 120 is optionally the same as or similar to the field of view of the user's eyes. In some examples, the field of view visible to the user is different from a field of view of external image sensors 114b and 114c (e.g., narrower than the field of view of external image sensors 114b and 114c). In other examples, the field of view of display 120 may be smaller than the field of view of the user's eyes. A viewpoint of a user determines what content is visible in the field of view, a viewpoint generally specfies a location and a direction relative to the three-dimensional environment. As the viewpoint of a user shifts, the field of view of the three-dimensional environment will also shift accordingly. In some examples, electronic device 101 may be an optical see-through device in which display 120 is a transparent or translucent display through which portions of the physical environment may be directly viewed. In some examples, display 120 may be included within a transparent lens and may overlap all or a portion of the transparent lens. In other examples, electronic device may be a video-passthrough device in which display 120 is an opaque display configured to display images of the physical environment using images captured by external image sensors 114b and 114c. While a single display is shown in FIG. 1, it is understood that display 120 optionally includes more than one display. For example, display 120 optionally includes a stereo pair of displays (e.g., left and right display panels for the left and right eyes of the user, respectively) having displayed outputs that are merged (e.g., by the user's brain) to create the view of the content shown in FIG. 1. In some examples, as discussed in more detail below with reference to FIGS. 2A-2B, the display 120 includes or corresponds to a transparent or translucent surface (e.g., a lens) that is not equipped with display capability (e.g., and is therefore unable to generate and display the virtual object 104) and alternatively presents a direct view of the physical environment in the user's field of view (e.g., the field of view of the user's eyes).

In some examples, the electronic device 101 is configured to display (e.g., in response to a trigger) a virtual object 104 in the three-dimensional environment. Virtual object 104 is represented by a cube illustrated in FIG. 1, which is not present in the physical environment, but is displayed in the three-dimensional environment positioned on the top of table 106 (e.g., real-world table or a representation thereof). Optionally, virtual object 104 is displayed on the surface of the table 106 in the three-dimensional environment displayed via the display 120 of the electronic device 101 in response to detecting the planar surface of table 106 in the physical environment 100.

It is understood that virtual object 104 is a representative virtual object and one or more different virtual objects (e.g., of various dimensionality such as two-dimensional or other three-dimensional virtual objects) can be included and rendered in a three-dimensional environment.

For example, the virtual object can represent an application or a user interface displayed in the three-dimensional environment. In some examples, the virtual object can represent content corresponding to the application and/or displayed via the user interface in the three-dimensional environment. In some examples, the virtual object 104 is optionally configured to be interactive and responsive to user input (e.g., air gestures, such as air pinch gestures, air tap gestures, and/or air touch gestures), such that a user may virtually touch, tap, move, rotate, or otherwise interact with, the virtual object 104.

As discussed herein, one or more air pinch gestures performed by a user (e.g., with hand 103 in FIG. 1) are detected by one or more input devices of electronic device 101 and interpreted as one or more user inputs directed to content displayed by electronic device 101. Additionally or alternatively, in some examples, the one or more user inputs interpreted by the electronic device 101 as being directed to content displayed by electronic device 101 (e.g., the virtual object 104) are detected via one or more hardware input devices (e.g., controllers, touch pads, proximity sensors, buttons, sliders, knobs, etc.) rather than via the one or more input devices that are configured to detect air gestures, such as the one or more air pinch gestures, performed by the user. Such depiction is intended to be exemplary rather than limiting; the user optionally provides user inputs using different air gestures and/or using other forms of input.

In some examples, the electronic device 101 may be configured to communicate with a second electronic device, such as a companion device. For example, as illustrated in FIG. 1, the electronic device 101 is optionally in communication with electronic device 160. In some examples, electronic device 160 corresponds to a mobile electronic device, such as a smartphone, a tablet computer, a smart watch, a laptop computer, or other electronic device. In some examples, electronic device 160 corresponds to a non-mobile electronic device, which is generally stationary and not easily moved within the physical environment (e.g., desktop computer, server, etc.). Additional examples of electronic device 160 are described below with reference to the architecture block diagram of FIG. 2B. In some examples, the electronic device 101 and the electronic device 160 are associated with a same user. For example, in FIG. 1, the electronic device 101 may be positioned on (e.g., mounted to) a head of a user and the electronic device 160 may be positioned near electronic device 101, such as in a hand 103 of the user (e.g., the hand 103 is holding the electronic device 160), a pocket or bag of the user, or a surface near the user. The electronic device 101 and the electronic device 160 are optionally associated with a same user account of the user (e.g., the user is logged into the user account on the electronic device 101 and the electronic device 160). Additional details regarding the communication between the electronic device 101 and the electronic device 160 are provided below with reference to FIGS. 2A-2B.

In some examples, displaying an object in a three-dimensional environment is caused by or enables interaction with one or more user interface objects in the three-dimensional environment. For example, initiation of display of the object in the three-dimensional environment can include interaction with one or more virtual options/affordances displayed in the three-dimensional environment. In some examples, a user's gaze may be tracked by the electronic device as an input for identifying one or more virtual options/affordances targeted for selection when initiating display of an object in the three-dimensional environment. For example, gaze can be used to identify one or more virtual options/affordances targeted for selection using another selection input. In some examples, a virtual option/affordance may be selected using hand-tracking input detected via an input device in communication with the electronic device. In some examples, objects displayed in the three-dimensional environment may be moved and/or reoriented in the three-dimensional environment in accordance with movement input detected via the input device.

In the descriptions that follows, an electronic device that is in communication with one or more displays and one or more input devices is described. It is understood that the electronic device optionally is in communication with one or more other physical user-interface devices, such as a touch-sensitive surface, a physical keyboard, a mouse, a joystick, a hand tracking device, an eye tracking device, a stylus, etc. Further, as described above, it is understood that the described electronic device, display and touch-sensitive surface are optionally distributed between two or more devices. Therefore, as used in this disclosure, information displayed on the electronic device or by the electronic device is optionally used to describe information outputted by the electronic device for display on a separate display device (touch-sensitive or not). Similarly, as used in this disclosure, input received on the electronic device (e.g., touch input received on a touch-sensitive surface of the electronic device, or touch input received on the surface of a stylus) is optionally used to describe input received on a separate input device, from which the electronic device receives input information.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, a television channel browsing application, and/or a digital video player application.

FIGS. 2A-2B illustrate block diagrams of example architectures for electronic devices or systems according to some examples of the disclosure. In some examples, electronic device 201 and/or electronic device 260 include one or more electronic devices. For example, the electronic device 201 may be a portable device, an auxiliary device in communication with another device, a head-mounted display, a head-worn speaker, etc., respectively. In some examples, electronic device 201 corresponds to electronic device 101 described above with reference to FIG. 1. In some examples, electronic device 260 corresponds to electronic device 160 described above with reference to FIG. 1.

As illustrated in FIG. 2A, the electronic device 201 optionally includes one or more sensors, such as one or more hand tracking sensors 202, one or more location sensors 204A, one or more image sensors 206A (optionally corresponding to internal image sensors 114a and/or external image sensors 114b and 114c in FIG. 1), one or more touch-sensitive surfaces 209A, one or more motion and/or orientation sensors 210A, one or more eye tracking sensors 212, one or more microphones 213A or other audio sensors, one or more body tracking sensors (e.g., torso and/or head tracking sensors), etc. The electronic device 201 optionally includes one or more output devices, such as one or more display generation components 214A, optionally corresponding to display 120 in FIG. 1, one or more speakers 216A, one or more haptic output devices (not shown), etc. The electronic device 201 optionally includes one or more processors 218A, one or more memories 220A, and/or communication circuitry 222A. One or more communication buses 208A are optionally used for communication between the above-mentioned components of electronic device 201.

Additionally, the electronic device 260 optionally includes the same or similar components as the electronic device 201. For example, as shown in FIG. 2B, the electronic device 260 optionally includes one or more location sensors 204B, one or more image sensors 206B, one or more touch-sensitive surfaces 209B, one or more orientation sensors 210B, one or more microphones 213B, one or more display generation components 214B, one or more speakers 216B, one or more processors 218B, one or more memories 220B, and/or communication circuitry 222B. One or more communication buses 208B are optionally used for communication between the above-mentioned components of electronic device 260.

The electronic devices 201 and 260 are optionally configured to communicate via a wired or wireless connection (e.g., via communication circuitry 222A, 222B) between the two electronic devices. For example, as indicated in FIG. 2A, the electronic device 260 may function as a companion device to the electronic device 201. For example, in some examples, the electronic device 260 processes sensor inputs from electronic devices 201 and 260 and/or generates content for display using display generation components 214A of electronic device 201.

Communication circuitry 222A, 222B optionally includes circuitry for communicating with electronic devices, networks, such as the Internet, intranets, a wired network and/or a wireless network, cellular networks, and wireless local area networks (LANs). Communication circuitry 222A, 222B optionally includes circuitry for communicating using near-field communication (NFC) and/or short-range communication, such as Bluetooth®, etc. In some examples, communication circuitry 222A, 222B includes or supports Wi-Fi (e.g., an 802.11 protocol), Ethernet, ultra-wideband (“UWB”), high frequency systems (e.g., 900 MHz, 2.4 GHz, and 5.6 GHz communication systems), or any other communications protocol, or any combination thereof.

One or more processors 218A, 218B include one or more general processors, one or more graphics processors, and/or one or more digital signal processors. In some examples, one or more processors 218A, 218B include one or more microprocessors, one or more central processing units, one or more application-specific integrated circuits, one or more field-programmable gate arrays, one or more programmable logic devices, or a combination of such devices. In some examples, memories 220A and/or 220B are a non-transitory computer-readable storage medium (e.g., flash memory, random access memory, or other volatile or non-volatile memory or storage) that stores computer-readable instructions configured to be executed by the one or more processors 218A, 218B to perform the techniques, processes, and/or methods described herein. In some examples, memories 220A and/or 220B can include more than one non-transitory computer-readable storage medium. A non-transitory computer-readable storage medium can be any medium (e.g., excluding a signal) that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on compact disc (CD), digital versatile disc (DVD), or Blu-ray technologies, as well as persistent solid-state memory such as flash, solid-state drives, and the like.

In some examples, one or more display generation components 214A, 214B include a single display (e.g., a liquid-crystal display (LCD), organic light-emitting diode (OLED), or other types of display). In some examples, the one or more display generation components 214A, 214B include multiple displays. In some examples, the one or more display generation components 214A, 214B can include a display with touch capability (e.g., a touch screen), a projector, a holographic projector, a retinal projector, a transparent or translucent display, etc. In some examples, the electronic device does not include one or more display generation components 214A or 214B. For example, instead of the one or more display generation components 214A or 214B, some electronic devices include transparent or translucent lenses or other surfaces that are not configured to display or present virtual content. However, it should be understood that, in such instances, the electronic device 201 and/or the electronic device 260 are optionally equipped with one or more of the other components illustrated in FIGS. 2A and 2B and described herein, such as the one or more hand tracking sensors 202, one or more eye tracking sensors 212, one or more image sensors 206A, and/or the one or more motion and/or orientations sensors 210A. Alternatively, in some examples, the one or more display generation components 214A or 214B are provided separately from the electronic devices 201 and/or 260. For example, the one or more display generation components 214A, 214B are in communication with the electronic device 201 (and/or electronic device 260), but are not integrated with the electronic device 201 and/or electronic device 260 (e.g., within a housing of the electronic devices 201, 260). In some examples, electronic devices 201 and 260 include one or more touch-sensitive surfaces 209A and 209B, respectively, for receiving user inputs, such as tap inputs and swipe inputs or other gestures (e.g., hand-based or finger-based gestures). In some examples, the one or more display generation components 214A, 214B and the one or more touch-sensitive surfaces 209A, 209B form one or more touch-sensitive displays (e.g., a touch screen integrated with each of electronic devices 201 and 260 or external to each of electronic devices 201 and 260 that is in communication with each of electronic devices 201 and 260).

Electronic devices 201 and 260 optionally include one or more image sensors 206A and 206B, respectively. The one or more image sensors 206A, 206B optionally include one or more visible light image sensors, such as charged coupled device (CCD) sensors, and/or complementary metal-oxide-semiconductor (CMOS) sensors operable to obtain images of physical objects from the real-world environment. The one or more image sensors 206A, 206B also optionally include one or more infrared (IR) sensors, such as a passive or an active IR sensor, for detecting infrared light from the real-world environment. For example, an active IR sensor includes an IR emitter for emitting infrared light into the real-world environment. The one or more image sensors 206A, 206B also optionally include one or more cameras configured to capture movement of physical objects in the real-world environment. The one or more image sensors 206A, 206B also optionally include one or more depth sensors configured to detect the distance of physical objects from electronic device 201, 260. In some examples, information from one or more depth sensors can allow the device to identify and differentiate objects in the real-world environment from other objects in the real-world environment. In some examples, one or more depth sensors can allow the device to determine the texture and/or topography of objects in the real-world environment. In some examples, the one or more image sensors 206A or 206B are included in an electronic device different from the electronic devices 201 and/or 260. For example, the one or more image sensors 206A, 206B are in communication with the electronic device 201, 260, but are not integrated with the electronic device 201, 260 (e.g., within a housing of the electronic device 201, 260). Particularly, in some examples, the one or more cameras of the one or more image sensors 206A, 206B are integrated with and/or coupled to one or more separate devices from the electronic devices 201 and/or 260 (e.g., but are in communication with the electronic devices 201 and/or 260), such as one or more input and/or output devices (e.g., one or more speakers and/or one or more microphones, such as earphones or headphones) that include the one or more image sensors 206A, 206B. In some examples, electronic device 201 or electronic device 260 corresponds to a head-worn speaker (e.g., headphones or earbuds). In such instances, the electronic device 201 or the electronic device 260 is equipped with a subset of the other components illustrated in FIGS. 2A and 2B and described herein. In some such examples, the electronic device 201 or the electronic device 260 is equipped with one or more image sensors 206A, 206B, the one or more motion and/or orientations sensors 210A, 210B, and/or speakers 216A, 216B.

In some examples, electronic device 201, 260 uses CCD sensors, event cameras, and depth sensors in combination to detect the physical environment around electronic device 201, 260. In some examples, the one or more image sensors 206A, 206B include a first image sensor and a second image sensor. The first image sensor and the second image sensor work in tandem and are optionally configured to capture different information of physical objects in the real-world environment. In some examples, the first image sensor is a visible light image sensor, and the second image sensor is a depth sensor. In some examples, electronic device 201, 260 uses the one or more image sensors 206A, 206B to detect the position and orientation of electronic device 201, 260 and/or the one or more display generation components 214A, 214B in the real-world environment. For example, electronic device 201, 260 uses the one or more image sensors 206A, 206B to track the position and orientation of the one or more display generation components 214A, 214B relative to one or more fixed objects in the real-world environment.

In some examples, electronic devices 201 and 260 include one or more microphones 213A and 213B, respectively, or other audio sensors. Electronic device 201, 260 optionally uses the one or more microphones 213A, 213B to detect sound from the user and/or the real-world environment of the user. In some examples, the one or more microphones 213A, 213B include an array of microphones (e.g., a plurality of microphones) that optionally operate in tandem, such as to identify ambient noise or to locate the source of sound in space of the real-world environment.

Electronic devices 201 and 260 include one or more location sensors 204A and 204B, respectively, for detecting a location of electronic device 201 and/or the one or more display generation components 214A and a location of electronic device 260 and/or the one or more display generation components 214B, respectively. For example, the one or more location sensors 204A, 204B can include a global positioning system (GPS) receiver that receives data from one or more satellites and allows electronic device 201, 260 to determine the absolute position of the electronic device in the physical world.

Electronic devices 201 and 260 include one or more orientation sensors 210A and 210B, respectively, for detecting orientation and/or movement of electronic device 201 and/or the one or more display generation components 214A and orientation and/or movement of electronic device 260 and/or the one or more display generation components 214B, respectively. For example, electronic device 201, 260 uses the one or more orientation sensors 210A, 210B to track changes in the position and/or orientation of electronic device 201, 260 and/or the one or more display generation components 214A, 214B, such as with respect to physical objects in the real-world environment. The one or more orientation sensors 210A, 210B optionally include one or more gyroscopes and/or one or more accelerometers.

Electronic device 201 includes one or more hand tracking sensors 202 and/or one or more eye tracking sensors 212, in some examples. It is understood, that although referred to as hand tracking or eye tracking sensors, that electronic device 201 additionally or alternatively optionally includes one or more other body tracking sensors, such as one or more leg, one or more torso and/or one or more head tracking sensors. The one or more hand tracking sensors 202 are configured to track the position and/or location of one or more portions of the user's hands, and/or motions of one or more portions of the user's hands with respect to the three-dimensional environment, relative to the one or more display generation components 214A, and/or relative to another defined coordinate system. The one or more eye tracking sensors 212 are configured to track the position and movement of a user's gaze (e.g., a user's attention, including eyes, face, or head, more generally) with respect to the real-world or three-dimensional environment and/or relative to the one or more display generation components 214A. In some examples, the one or more hand tracking sensors 202 and/or the one or more eye tracking sensors 212 are implemented together with the one or more display generation components 214A. In some examples, the one or more hand tracking sensors 202 and/or the one or more eye tracking sensors 212 are implemented separate from the one or more display generation components 214A. In some examples, electronic device 201 alternatively does not include the one or more hand tracking sensors 202 and/or the one or more eye tracking sensors 212. In some such examples, the one or more display generation components 214A may be utilized by the electronic device 260 to provide a three-dimensional environment and the electronic device 260 may utilize input and other data gathered via the other one or more sensors (e.g., the one or more location sensors 204A, the one or more image sensors 206A, the one or more touch-sensitive surfaces 209A, the one or more motion and/or orientation sensors 210A, and/or the one or more microphones 213A or other audio sensors) of the electronic device 201 as input and data that is processed by the one or more processors 218B of the electronic device 260. Additionally or alternatively, electronic device 260 optionally does not include other components shown in FIG. 2B, such as the one or more location sensors 204B, the one or more image sensors 206B, the one or more touch-sensitive surfaces 209B, etc. In some such examples, the one or more display generation components 214A may be utilized by the electronic device 260 to provide a three-dimensional environment and the electronic device 260 may utilize input and other data gathered via the one or more motion and/or orientation sensors 210A (and/or the one or more microphones 213A) of the electronic device 201 as input.

In some examples, the one or more hand tracking sensors 202 (and/or other body tracking sensors, such as leg, torso and/or head tracking sensors) can use the one or more image sensors 206 (e.g., one or more IR cameras, 3D cameras, depth cameras, etc.) that capture three-dimensional information from the real-world including one or more body parts (e.g., hands, legs, or torso of a human user). In some examples, the hands can be resolved with sufficient resolution to distinguish fingers and their respective positions. In some examples, the one or more image sensors 206A are positioned relative to the user to define a field of view of the one or more image sensors 206A and an interaction space in which finger/hand position, orientation and/or movement captured by the image sensors are used as inputs (e.g., to distinguish from a user's resting hand or other hands of other persons in the real-world environment). Tracking the fingers/hands for input (e.g., gestures, touch, tap, etc.) can be advantageous in that it does not require the user to touch, hold or wear any sort of beacon, sensor, or other marker.

In some examples, the one or more eye tracking sensors 212 include at least one eye tracking camera (e.g., IR cameras) and/or illumination sources (e.g., IR light sources, such as LEDs) that emit light towards a user's eyes. The eye tracking cameras may be pointed towards a user's eyes to receive reflected IR light from the light sources directly or indirectly from the eyes. In some examples, both eyes are tracked separately by respective eye tracking cameras and illumination sources, and a focus/gaze can be determined from tracking both eyes. In some examples, one eye (e.g., a dominant eye) is tracked by one or more respective eye tracking cameras/illumination sources.

Electronic devices 201 and 260 are not limited to the components and configuration of FIGS. 2A-2B, but can include fewer, other, or additional components in multiple configurations. In some examples, electronic device 201 and/or electronic device 260 can each be implemented between multiple electronic devices (e.g., as a system). In some such examples, each of (or more of) the electronic devices may include one or more of the same components discussed above, such as various sensors, one or more display generation components, one or more speakers, one or more processors, one or more memories, and/or communication circuitry. A person or persons using electronic device 201 and/or electronic device 260, is optionally referred to herein as a user or users of the device.

In some examples, it may be advantageous to provide mechanisms for facilitating a multi-user communication session that includes collocated users (e.g., co-located electronic devices associated with the users).

Some examples of the disclosure are directed to assignment and modification of virtual seating arrangements in a three-dimensional environment. For example, an electronic device in communication with one or more other electronic devices can display representations of users of the other electronic devices (and/or of the electronic devices). In some examples, to simulate the experience of being physically co-located with other users represented by the representations of the users, the electronic device can transmit and/or receive information such that some or all of the electronic devices in a communication session can display representations of other users in a shared virtual reality (VR), mixed reality (MR), and/or extended reality (XR) environment at particular locations and/or with particular orientations relative to each other.

In some examples, electronic devices engaged in the communication session can be associated with virtual seats. The virtual seats, for example, can have locations that are mapped to the physical portions of a three-dimensional environment and/or virtual portions of a three-dimensional environment of the electronic device. In some examples, the electronic device can facilitate exchanging of virtual seats. For example, some or all of the electronic devices in the communication session can establish virtual locations relative to a virtual environment shared via the communication session. In some examples, the electronic devices can each provide an input to exchange and/or swap virtual seats that is assigned to another electronic device in the communication session. In response to receiving an indication of the input requesting the swapping of virtual seats, the electronic devices can swap their virtual seats. In some examples, the swapping of the virtual seats includes displaying virtual content in accordance with an updated spatial relationship between a newly reassigned virtual seat and virtual content shared in the communication session. For example, similar to physically exchanging or swapping physical seats in a physical environment, an electronic device can update the position and/or orientation of virtual objects, representations of other users, visual representations of virtual seats, and/or some combination thereof when swapping a virtual seat to reflect that the electronic device is newly assigned to a new virtual seat. It is understood that examples described above are merely exemplary, and additional or alternative examples can be contemplated without departing from the scope of the present disclosure. By changing the position and/or orientation of the virtual content in response to inputs and/or satisfaction of criteria, an electronic device can improve and/or newly provide visibility of virtual content based on the updated position and/or orientation of the virtual content, optionally without detecting a change in viewpoint of the user that could otherwise be operative to perform a similar change in position and/or orientation of the virtual content. The electronic device therefore can reduce user inputs and/or processing to perform operations in response to such inputs, improving efficiency and function of the electronic device.

In some examples, electronic device 101 can be a first electronic device that is used by a first user, user 328, to access and participate in a communication session. For example, electronic device 101 can be a mobile device (e.g., a tablet, a smartphone, a media player, or a wearable device), or a computer or other electronic device. In some examples, the electronic device 101 is in communication with and/or includes one or more displays (e.g., display 120) and one or more input devices. In some examples, the display 120 is a display integrated with the electronic device (optionally a touch screen display), external display such as a monitor, projector, television, and/or a hardware component (optionally integrated or external) for projecting a user interface or causing a user interface to be visible to one or more users. In some examples, the one or more input devices include an electronic device or component capable of receiving a user input (e.g., capturing a user input, detecting a user input) and transmitting information associated with the user input to the electronic device. Examples of input devices include a touch screen, mouse (e.g., external), trackpad (optionally integrated or external), touchpad (optionally integrated or external), remote control device (e.g., external), another mobile device (e.g., separate from the electronic device), a handheld device (e.g., external), a controller (e.g., external), a camera, a depth sensor, an eye tracking device and/or a motion sensor (e.g., a hand tracking device, a hand motion sensor). In some examples, the electronic device is in communication with a hand tracking device (e.g., one or more cameras, depth sensors, proximity sensors, touch sensors (e.g., a touch screen, or trackpad)). In some examples, the hand tracking device is a wearable device, such as a smart glove. In some examples, the hand tracking device is a handheld input device, such as a remote control or stylus.

In some examples, electronic device 101 includes one or more displays 120 and a plurality of image sensors 114a-114c (e.g., image sensors 114 of FIG. 1). The image sensors optionally include one or more of a visible light camera, an infrared camera, a depth sensor, or any other sensor the electronic device 101 would be able to use to capture one or more images of a user or a part of the user (e.g., one or more hands of the user) while the user interacts with the electronic device 101. In some examples, the user interfaces illustrated and described below could also be implemented on a head-mounted display that includes one or more displays that presents the user interface or three-dimensional environment to the user, and sensors to detect the physical environment and/or movements of the user's hands (e.g., external sensors facing outwards from the user), and/or attention (e.g., based on gaze) of the user (e.g., internal sensors facing inwards towards the face of the user).

User 328 is located within three-dimensional environment 302, as illustrated in the top-down view of three-dimensional environment 302. Some examples described herein reference a viewpoint of electronic device 101 that has a position and an orientation relative to three-dimensional environment 302. It is understood, however, that the viewpoint of electronic device 101 can be similar to, or the same as, the viewpoint of user 328.

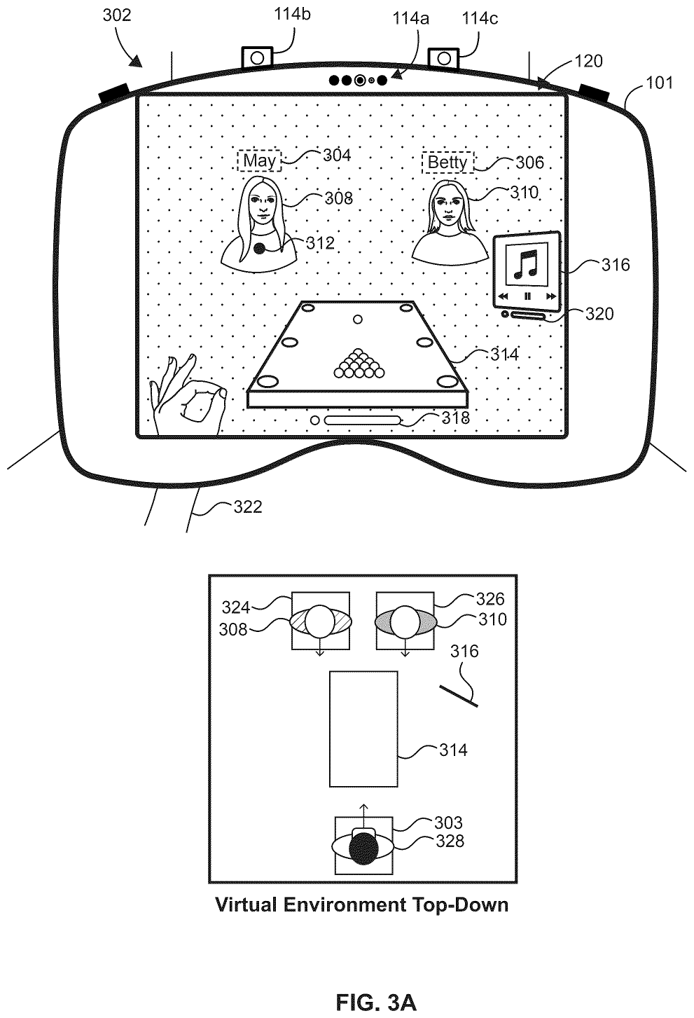

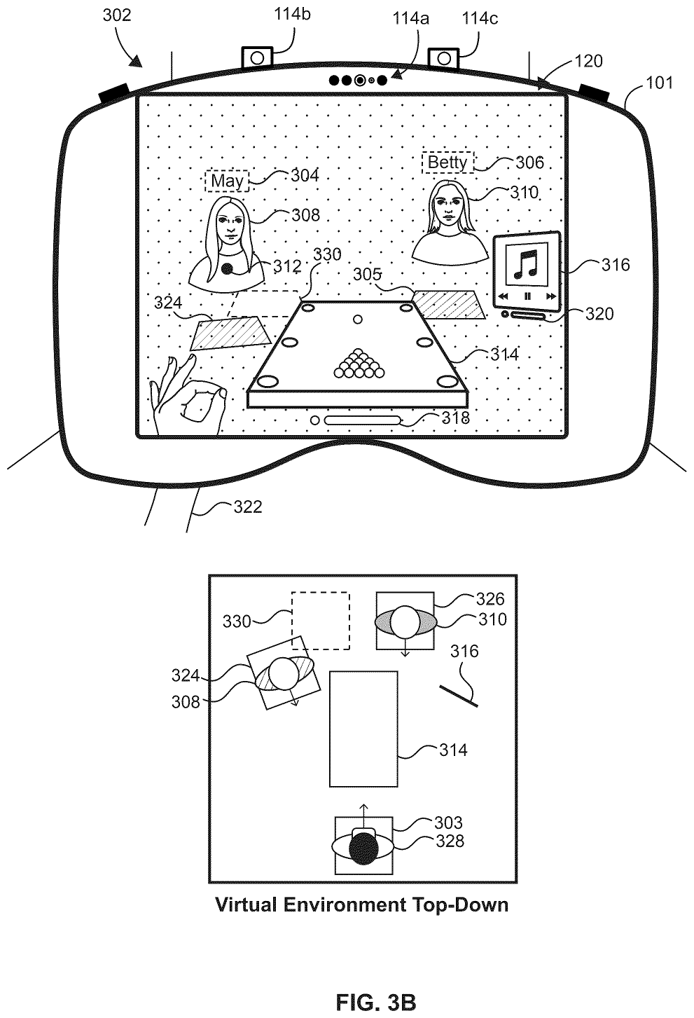

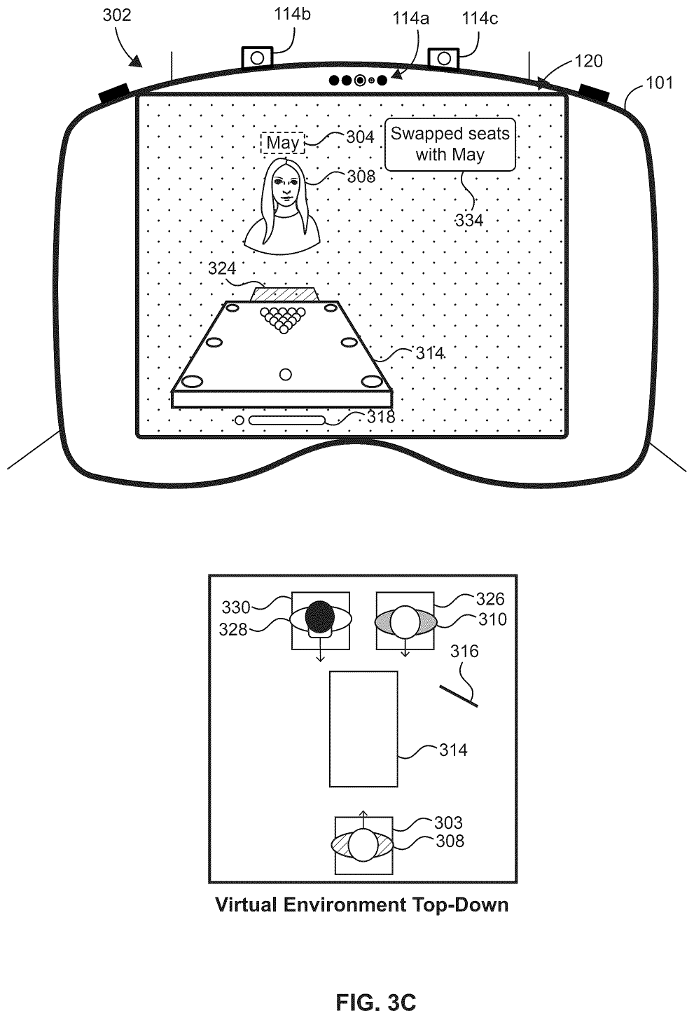

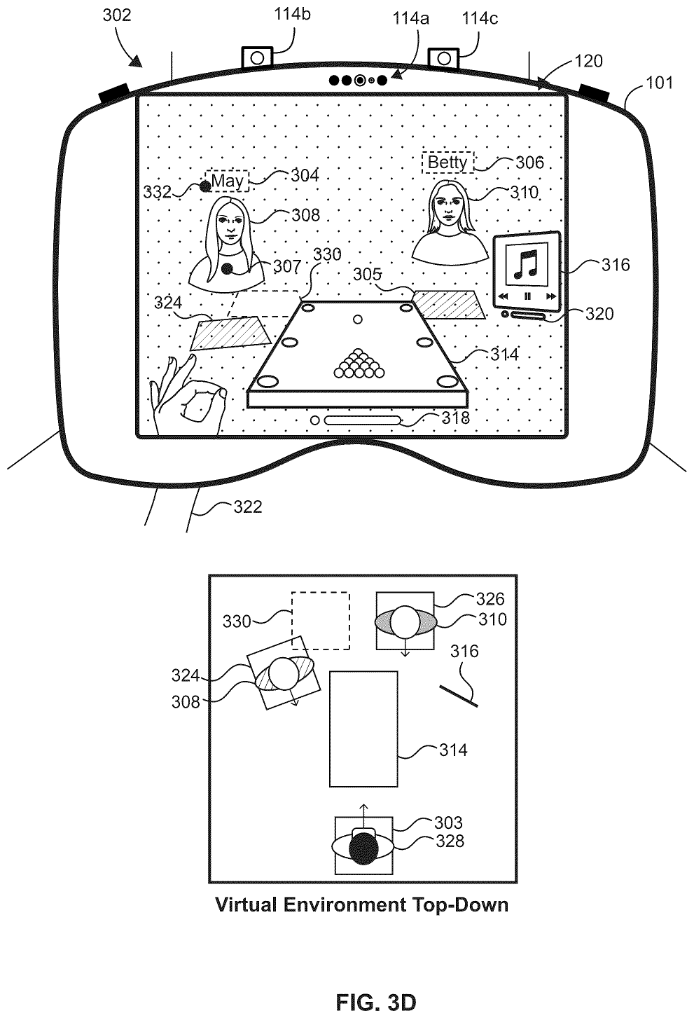

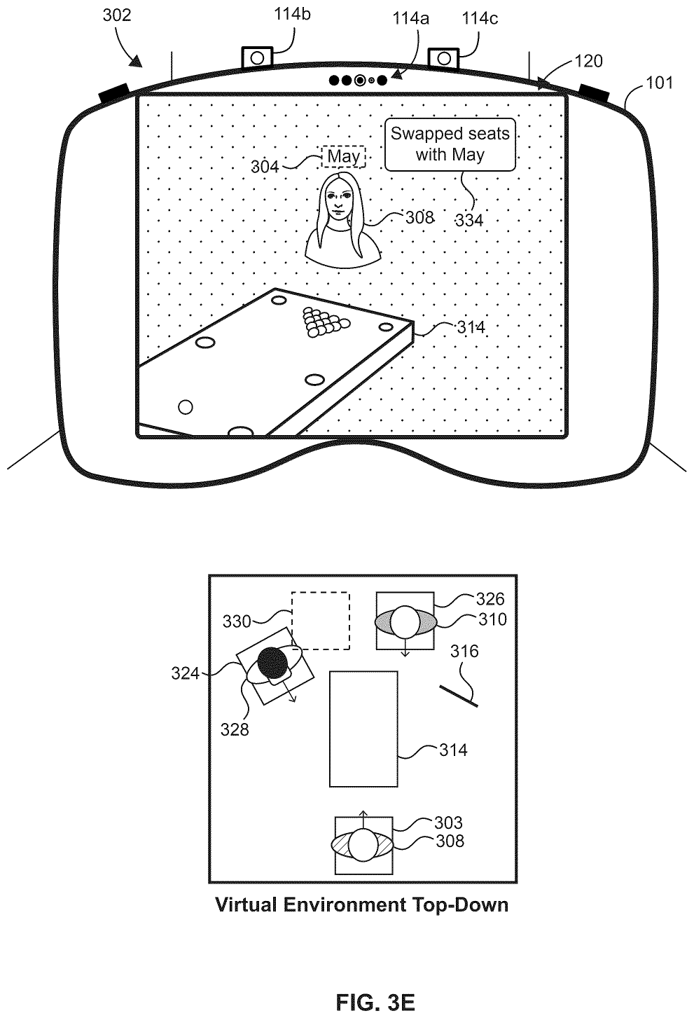

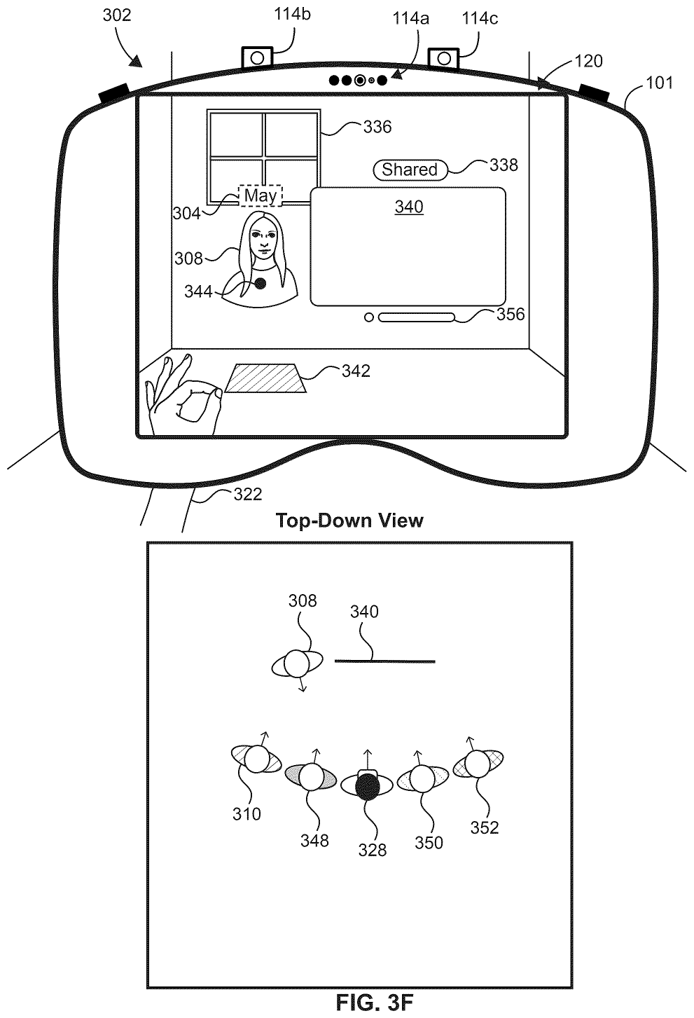

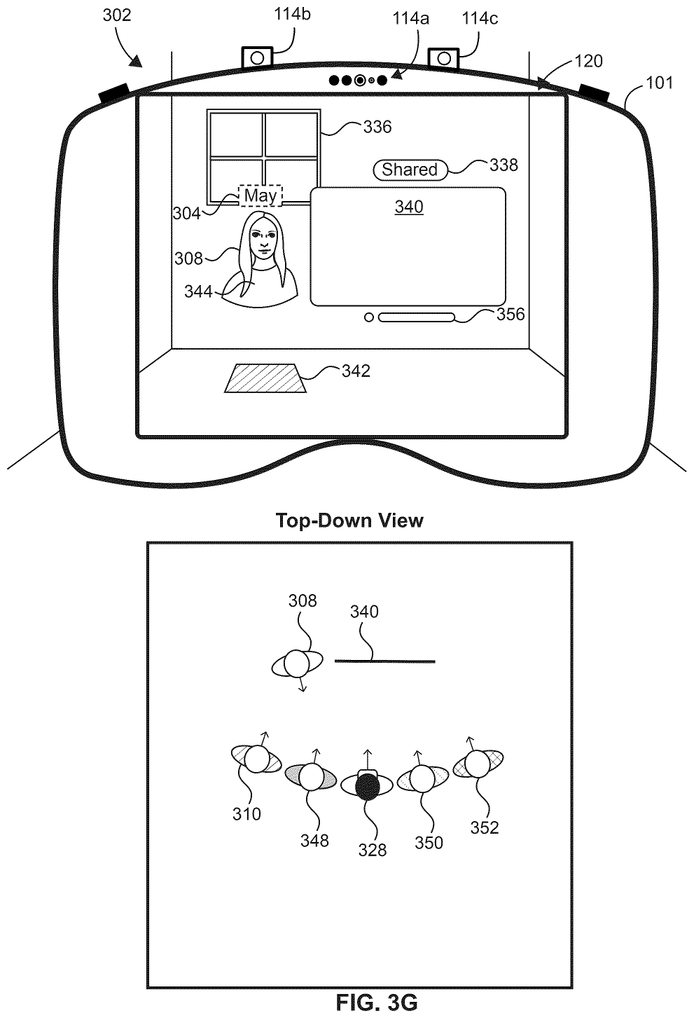

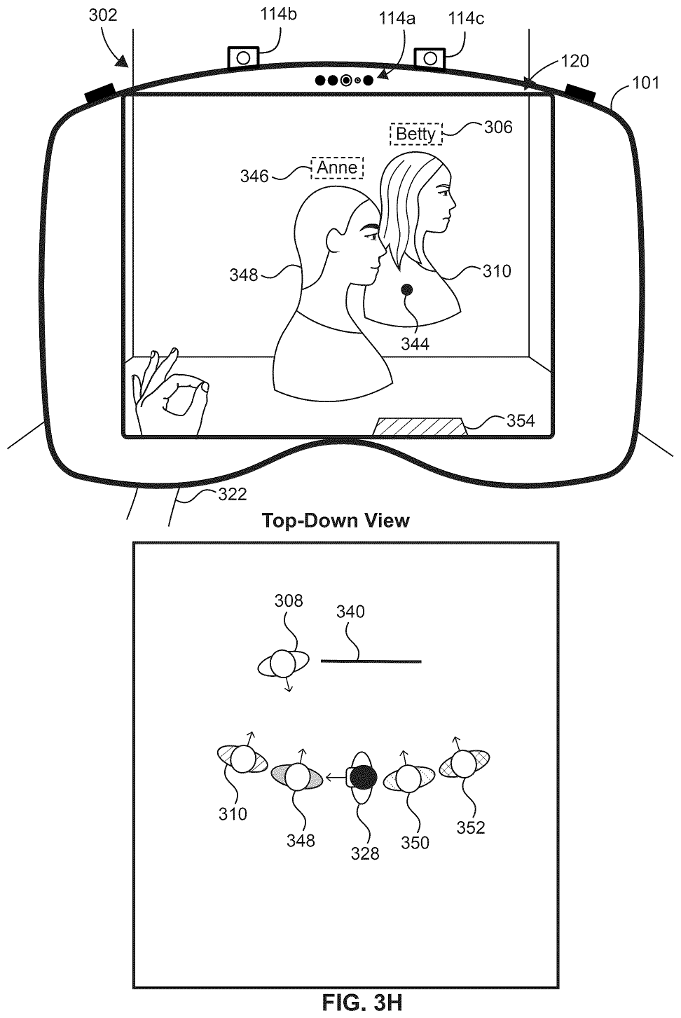

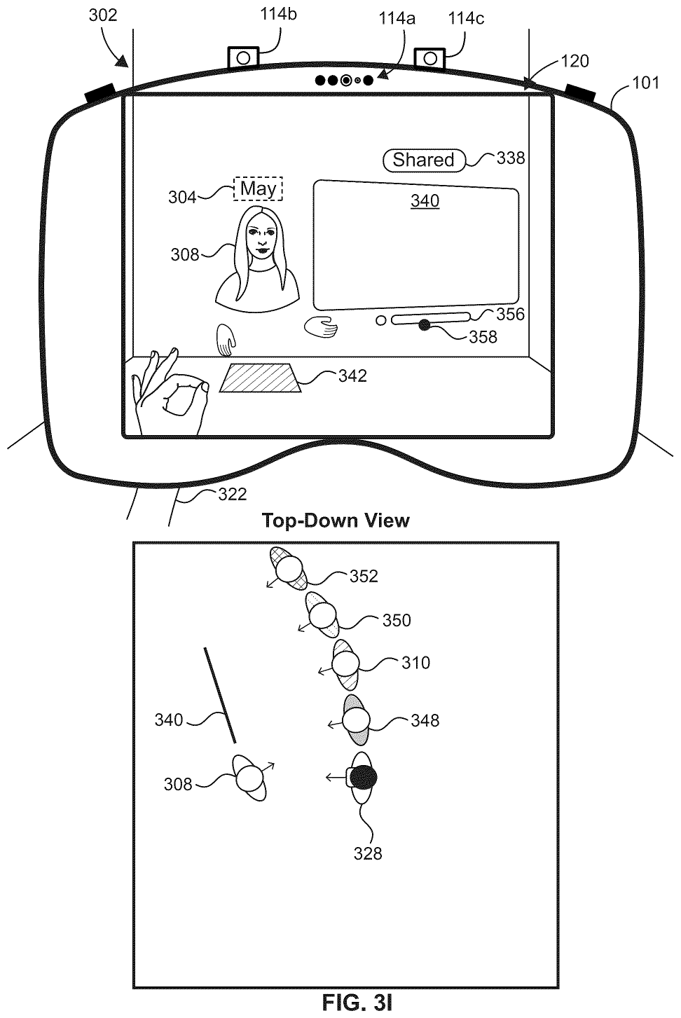

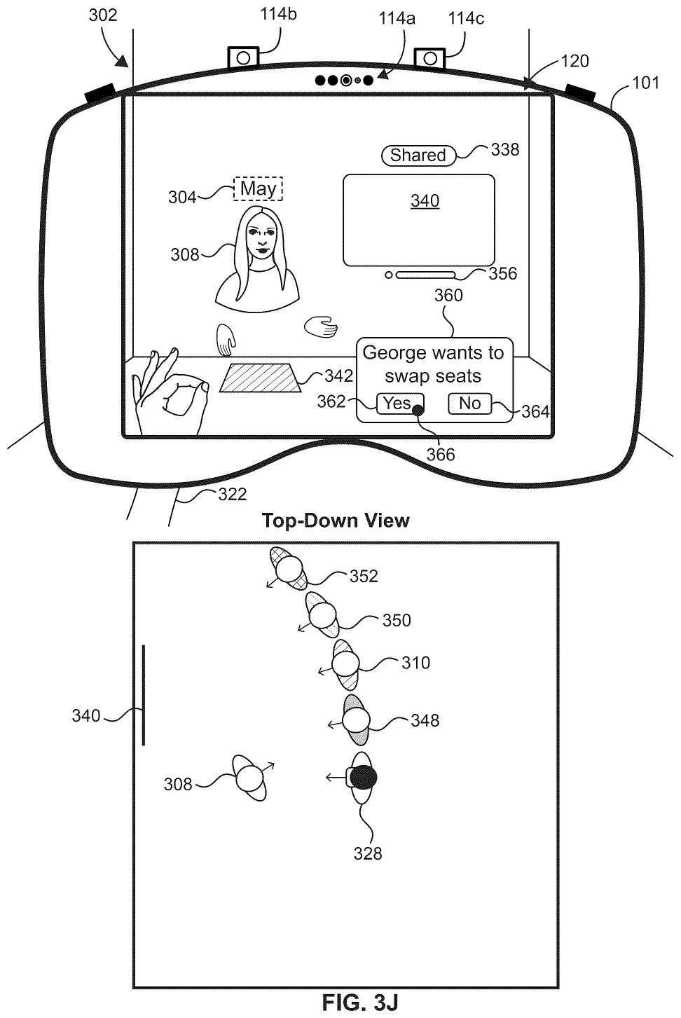

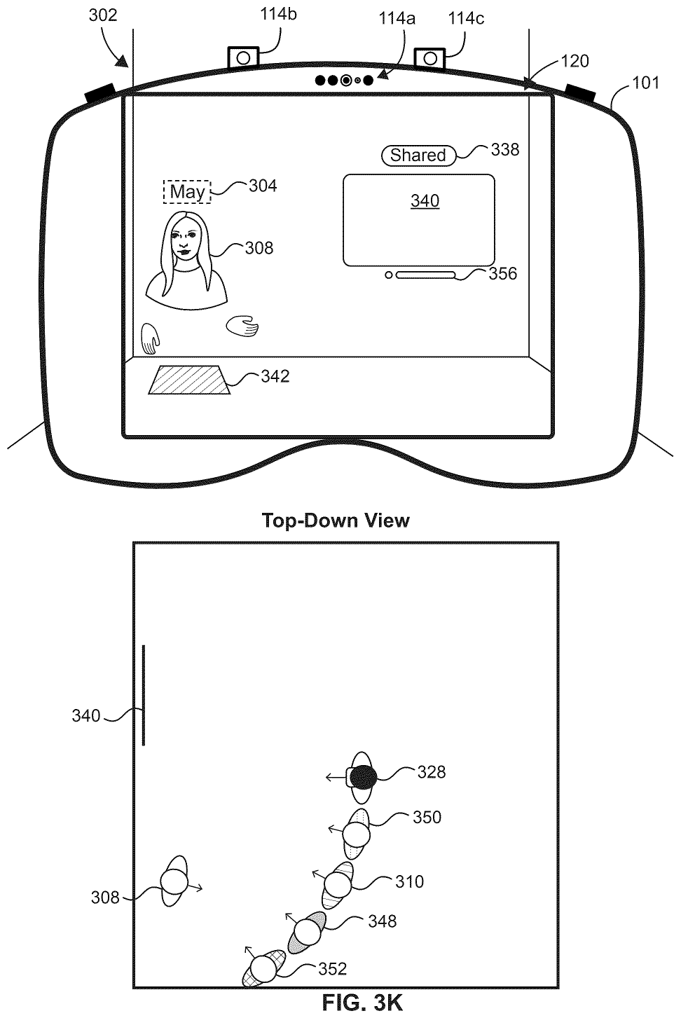

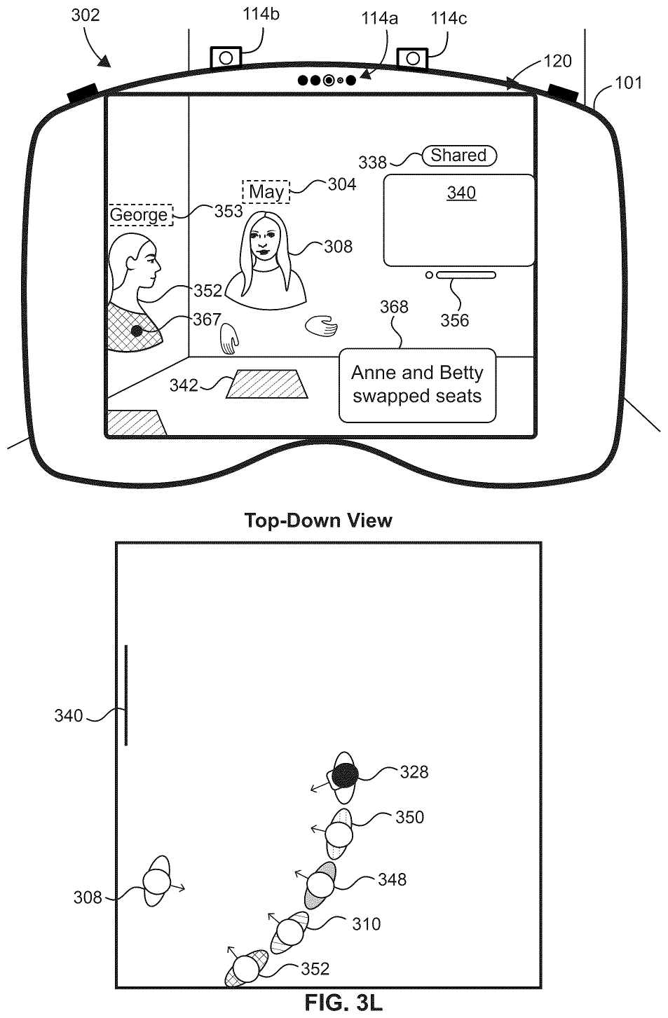

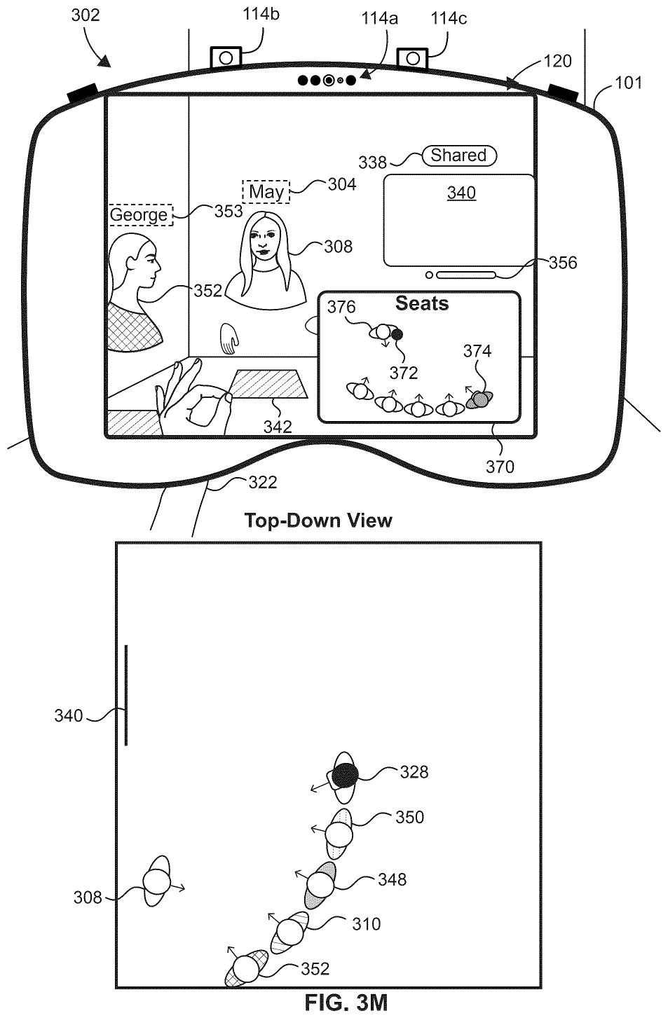

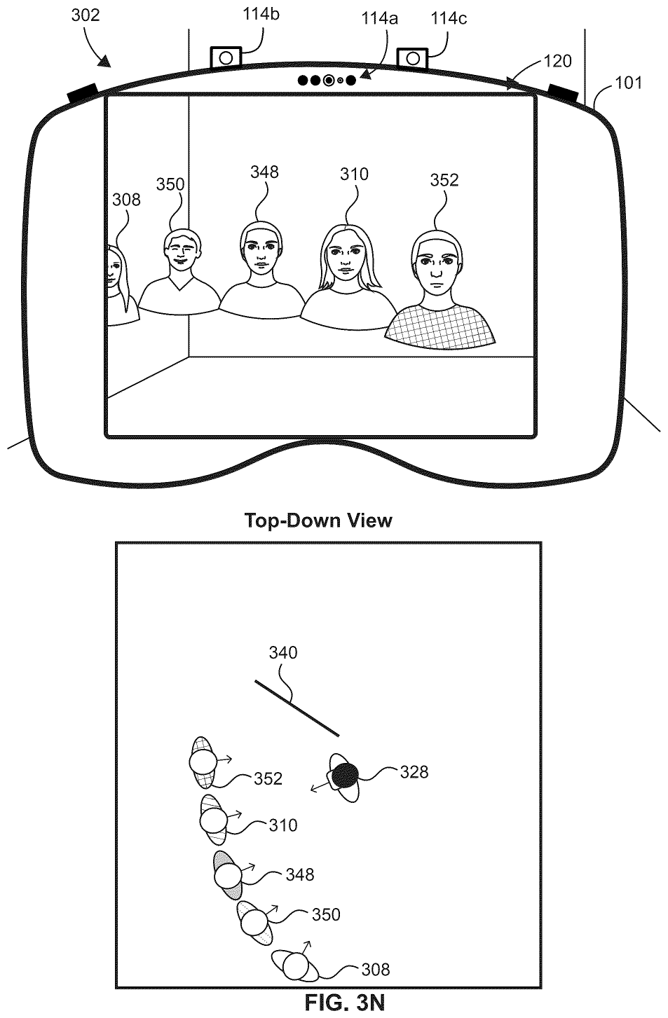

In some examples, the three-dimensional environment 302 is generated, displayed, or otherwise caused to be viewable by the device (e.g., a computer-generated reality (CGR) environment such as a virtual reality (VR) environment, a mixed reality (MR) environment, and/or an augmented reality (AR) environment). For example, three-dimensional environment 302 can include the physical environment and/or virtual environment of user 328 and electronic device 101. In some examples, user 328 in FIG. 3A has a spatial arrangement relative to physical aspects of the physical environment of user 328. In some examples, three-dimensional environment 302 includes virtual content such as virtual content shared via the communication session. As shown in FIG. 3A, user 328 can have a spatial arrangement relative to virtual content, such as virtual object 314 (described further herein). As shown in FIG. 3A, the spatial arrangement between the virtual content including virtual object 314, avatar 308, avatar 310, and the viewpoint of user 328 can be a first spatial arrangement. The spatial arrangement can change in response to movement of user 328, receiving an indication of movement corresponding to avatars 308 and/or 310, in response to receiving an input requesting a swapping and/or exchanging of virtual seats, and/or in response to receiving an input requesting alignment of shared virtual content with the viewpoint of electronic device 101 (e.g., as described further with reference to “recentering”of virtual content further herein).

In FIG. 3A, portions of a shared virtual environment included in three-dimensional environment 302 is illustrated in a top-down view glyph (e.g., “Virtual Environment Top-Down”). The glyph can represent a portion of the virtual environment, and can illustrate the spatial arrangement between user 328, virtual object 314, avatar 308, and avatar 310. It is understood that the glyph does not necessarily represent the physical spatial arrangement between user 328 and portions of the physical environment, such as the position and/or orientation of user 328 with respect to the physical walls, floor, and ceiling visible outside the dimensions of the electronic device 101.

In some examples, three-dimensional environment 302 includes virtual content such as virtual objects. For example, virtual object 314 can be a three-dimensional billiards table object. In some examples, the virtual object is optionally a user interface of an application containing content (e.g., including a plurality of selectable options), three-dimensional objects (e.g., virtual clocks, virtual balls, virtual cars, and/or fictitious entities such as a virtual dragon) or any other element displayed by electronic device 101 that is not included in the physical environment of display 120.

In some examples, three-dimensional environment 302 includes two-dimensional virtual content, such as virtual object 316. Virtual object 316 can be displayed with a simulated two-dimensional appearance, having one or two surfaces that include content such as user interfaces for software applications. As shown in FIG. 3A, for example, virtual object 316 is a user interface for a media player application used to present and/or interact with photos, videos, animation, music, sound recordings, and/or some combination thereof.

In some examples, user 328 and users of other electronic devices (e.g., another user participating in a real-time multi-user communication session with the user 328) can participate in a communication session via a first electronic device (e.g., electronic device 101) and/or the other electronic devices. In some examples, the real-time communication with the participant includes a real-time, or nearly real-time communication of voice and/or representations of the participant. For example, the first computer system optionally initiates and/or receives a request to initiate and/or join multi-user, and in response, initiates display of virtual content (e.g., in an at least partially immersive virtual environment) to facilitate communication with the participant within a shared virtual environment.

In some examples, electronic device 101 displays a virtual environment consuming some or all of a viewport of electronic device 101. For example, FIG. 3A illustrates a virtual environment indicated by the dotted fill pattern overlaying the interior dimensions of display 120. In some examples, the virtual environment can overlay or replace visibility of physical objects and features included in three-dimensional environment 302. For example, electronic device 101 can cease display of images (e.g., computer-generated representations or passthrough representations) of the physical environment detected by electronic device 101, and can replace such images with display of virtual content included in the virtual environment such as virtual trees, ground textures, virtual rocks, and/or a virtual sky. Additionally or alternatively, electronic device 101 can render the virtual content included in the virtual environment overlaying visible physical aspects of three-dimensional environment 302, such as overlaying visibility of a physical table that is visible to the viewer via a transparent piece of material included in display 120.

In some examples, electronic device 101 and/or other electronic devices participating in a communication session respectively display representations of other electronic devices in the communication session. For brevity, reference is made to representations of users of the electronic devices such as avatars. It is understood that a given electronic device can represent a user of another device and/or can represent the other device itself, by displaying a corresponding visual representation. Further, it is understood that a “user” of an electronic device participating in a communication session is, at times, referred to as a participant in the communication session.

In some examples, a visual representation of a user includes a virtual avatar and/or additional or alternative information related to the user and/or an electronic device of the user.

For example, FIG. 3A illustrates a plurality of representations, which includes avatar 308 and avatar 310. At times, user 328 is referred to herein as a “first user.” At times, a user corresponding to avatar 308 is referred to as a “second user.” At times, a user corresponding to avatar 310 is referred to as a “third user.”

In some examples, each of the first, second, and the third users participate in the multi-user communication via different respective devices. For example, user 328 participates via a first electronic device (e.g., electronic device 101), the second user participates via a second electronic device, different from electronic device 101, and/or the third user participates via a third electronic device, different from first (e.g., electronic device 101) and/or the second electronic device. In some examples, the first, second, and/or third electronic devices share one or more characteristics. For example, some or all of the electronic devices can be headset computing devices that include circuitry to collect spatial data, share spatial data via the communication session, and/or display virtual content (e.g., avatars 308 and/or 310) in accordance with spatial data received from the other electronic devices. Sharing spatial data may improve the likelihood that if the electronic devices are not co-located, there can be consistency and/or spatial truth regarding the arrangement of avatars and/or virtual content that are communicated via the communication session, which can improve the methods by which an electronic device is able to present a simulating of sharing of physical objects and/or a physical environment with other electronic devices.

In some examples, one or more of the electronic devices have characteristics that differ from the other electronic devices. For example, electronic device 101 can be a headset computing device, and the second electronic device can be cellular device, a tablet device, desktop computing device, and/or a laptop computing device. In such an example, the second electronic device does not include and/or forgoes use of circuitry used to collect spatial data, to render images with a simulated immersive experience, and/or display virtual content overlaying images of the physical environment that electronic device 101 uses during the communication session.

In some examples, while concurrently displaying avatars 308 and 310, electronic device 101 further concurrently displays information, such as information 304 and/or information 306, which respectively correspond to identifiers of users of devices corresponding to avatars 308 and 310. For example, avatar 308 can correspond to a second user of a second electronic device, different from electronic device 101 and different from user 328, to participate in the communication session. Additionally, avatar 310 can correspond to a third user of a third electronic device, different from electronic device 101, user 328, the second electronic device, and the second user, to participate in the communication session.

In some examples, the visual representation of a user includes one or more virtual avatars corresponding to a user of a device (e.g., having one or more visual characteristics corresponding to one or more physical characteristics of the participant, such as the user's height, posture, skin color, eye color, hair color, relative physical dimensions, facial features and/or position within the three-dimensional environment). In some examples, electronic device 101 displays the representation of the user with a visual appearance having a degree of visual prominence relative to the three-dimensional environment. The degree of visual prominence optionally corresponds to a form of the representation of the participant (e.g., an avatar having a human-like form and/or appearance or an abstracted avatar including less human-like form (e.g., corresponding to a generic two-dimensional or three-dimensional object, such as a virtual coin or a virtual sphere)). Additionally or alternatively, one or more portions of the representation of the participant are optionally displayed with one or more visual characteristics (e.g., with a level of opacity, saturation, brightness, contrast, a blurring effect, and/or a radius of a blurring effect) which are included in the displaying the first degree of visual prominence.

In some examples, electronic device 101 presents (e.g., plays back) audio corresponding to audio that is detected by the electronic device of the participant, and is communicated by the second user and/or the third user corresponding to avatars 308 and 310, respectively. In some examples, the audio is acoustically processed to provide a simulated localization of one or more sound sources providing the audio to the user, to mimic the effect of sound emanating from one or more respective positions in three-dimensional environment 302. For example, the audio is optionally configured to sound as though the visual representation of the participant is speaking, such as from a position relative to a floor of the three-dimensional environment and the viewpoint of the user corresponding to where the visual representation is displayed. In some examples, the audio is modified to sound as though the audio emanates from a head and/or a center of a body of an avatar. In some examples, electronic device 101 detects audio generated by user 328 (e.g., speech that is detected via one or more microphones of the electronic device 101), and communicates the audio to other participating electronic devices in the communication session, and the recipient electronic devices can present the audio in a manner similar to as described with reference to electronic device 101.

As described above, the users can be arranged in a spatial template while engaged in the communication session, such as a template that includes the virtual seats and virtual object 314 as shown in FIG. 3A. In some examples, a first spatial arrangement includes an arrangement of the one or more representations of users participating in the multi-user communication session relative to each other, optionally corresponding to slots in a first pre-defined template that specifies a first quantity of virtual locations (e.g., virtual seats at which respective users of the first quantity of users are placed) within the three-dimensional environment.

In some examples, a template is associated with a shape (e.g., a circle having a particular radius, a square having sides of a particular length, an arc of a circle having a particular radius, a line, or another shape) having a perimeter on which a particular quantity of virtual seats are arranged and at which representations and/or viewpoints of users can be placed (e.g., automatically, by electronic device 101). For example, a first ring template optionally is associated with a circle of a first radius that includes a first quantity of virtual seats (e.g., virtual locations) that can be used to arrange a first quantity of representations and/or viewpoints of users along the perimeter of the circle. A second ring template can be associated with a circle of a second radius and/or a different quantity of slots that can optionally be used to arrange a different quantity of representations and/or viewpoints of users.

In some examples, the spatial arrangement includes a distance and/or facing direction of the representation of the second user relative to the viewpoint of the first user and/or relative to any additional users in the multi-user communication session. As an example, the participants arranged in a ring template can face each other and/or a central point the interior of the ring shape. In some examples, the first virtual location for the second user is optionally a first distance from the first virtual location associated with the viewpoint of the first user, and/or the representation of the second user is facing the viewpoint of the first user such that the representation of the second user appears to be facing the first user (e.g., as displayed via the display of the electronic device 101). Optionally, the representation of the second user is not facing the representation of the first user but is instead facing the same virtual location (e.g., a focal point and/or center of the template) as the viewpoint of the first user.

Optionally, the electronic device associates (e.g., assigns) the first virtual location associated with the viewpoint of the first user with a first physical location of the first user in a physical environment of the first user (e.g., a physical location of the user when the representation of the second user is initially displayed). For example, at the time when the electronic device initiates display of the representation of the second user at the first virtual location for the second user and selects and/or changes the first virtual location associated with the viewpoint of the first user according to the first spatial arrangement, the electronic device optionally associates the first virtual location associated with the viewpoint of the first user with the current physical location of the first user such that when the first user changes physical locations (e.g., by walking to another physical location), the viewpoint of the first user changes from the first virtual location associated with the viewpoint of the first user to a different virtual location based on the change in physical location.

In some examples, a shared activity includes an activity in which virtual content-such as a movie, game, map, image, application window, or other content-is accessible to (e.g., visible to, audible to, and/or capable of being viewed, heard, and/or interacted with) multiple participants in the session. In some examples, as the virtual content has been shared by one or more of the participants. In some examples, the first type of shared activity corresponds to an activity in which participants are viewing and/or interacting with content that is vertically displayed, such as media content or an application window. In some examples, the first type of shared activity corresponds to an activity in which participants are viewing and/or interacting with content that is horizontally displayed (e.g., horizontally oriented), such as a board game or horizontal map. In some examples, the electronic device selects a template (e.g., for arranging participants) based on the type of shared activity. For example, if the first type of shared activity corresponds to viewing a movie (e.g., vertically displayed content), the electronic device optionally selects a first template, a content-viewing template, which arranges participants in a line or arc facing the movie. For example, if the first type of shared activity corresponds to playing a horizontally displayed game, the electronic device optionally selects a second template, a ring template, which arranges participants around the game. In some examples, if participants are not participating in a shared activity (e.g., there is no shared virtual content) or the participants are participating in a second type of shared activity different from the first type of shared activity, the participants are arranged in different virtual locations corresponding to slots in a different template, such as slots of a ring template and/or slots of a template corresponding to the second type of shared activity. In some examples, sharing virtual content allows the electronic devices to interact with a same set or a similar set of virtual content that is impossible too share or is more difficult when the electronic devices are not co-located.

The realignment of shared virtual content is at times referred to herein as “recentering” and/or recentering of virtual content. As described further with reference to FIG. 3H, electronic device 101 optionally performs recentering in response to detecting one or more inputs, such as an input requesting the swapping of virtual seats and/or an input expressly requesting recentering (e.g., optionally without swapping virtual seats). A recentering input, for example, can include pressing of a button included in electronic device 101, a voice command requesting the recentering, performance of an air gesture, and/or some combination there. In some examples, electronic device 101 performs recentering in response to detecting a first input modality (e.g., touch, air gesture, voice command, pressing of a particular button, pressing of a button with a force and/or for a duration greater than a threshold amount of force and/or duration), and electronic device 101 performs virtual seat swapping or another operation in response to detecting a second input modality (e.g., touch, air gesture, voice command, pressing of a particular button, pressing of a button with a force and/or for a duration greater than a threshold amount of force and/or duration), different from the first input modality. For example, electronic device 101 can perform virtual seat swapping in response to detecting an air gesture while attention is directed toward a virtual avatar, or can recenter shared virtual content to align with a center of a viewpoint of electronic device 101 in response to detecting pressing of a button for a period of time greater than a threshold amount of time.

As described above, the communication session can be associated with a virtual environment, shared virtual content, and/or a virtual seating arrangement. In some examples, a virtual seat includes a position within the shared virtual environment to which a user participating in the communication session is assigned. The virtual seat, as one example, can define the position of user 328 relative to other virtual seats and shared virtual content when a communication session is initiated. Consequentially, the virtual seat can define the spatial arrangement that virtual content is displayed relative to a viewpoint of electronic device 101 (e.g., when user 328 joins the communication session and/or when the virtual environment and/or shared virtual content is initially displayed).

Additionally or alternatively, the virtual seating assignment can define the spatial arrangement of virtual content that is displayed in response to detecting an event associated with causing users to return to the virtual seating assignment. In some examples, the event includes detecting that one or more users are entering or exiting the communication session. In some examples, the event is another event different from the one or more users entering or exiting the communication session. Thus, the input initiating the swapping or exchanging of virtual seats can allow the electronic device to present virtual content (e.g., in response to a recentering input) from a perspective relative to the viewpoint of the user that corresponds to the new seat.

In some examples, the event includes detecting one or more inputs and/or one or more indications of one or more inputs received from other electronic devices in the communication session interacting with shared virtual content. For example, the event can include detecting an input or indication that a user has changed the shared virtual content, has changed a spatial template and/or virtual seating arrangement while maintaining display of shared virtual content, has requested ceasing of sharing of the shared virtual content, has added or removed virtual objects included in the shared virtual content, and/or some combination thereof. In some example, the event is different from detecting movement of the viewpoint of the user (e.g., the position and/or orientation of electronic device 101 relative to the physical environment).

As illustrated in the top-down view of three-dimensional environment 302 shown in FIG. 3A, user 328 can occupy and/or be assigned a first virtual seat, such as first virtual seat 303 in the virtual seating arrangement. Avatar 308 can be assigned a second virtual seat corresponding to a second virtual seat 330, and avatar 310 can be assigned to third virtual seat corresponding to a third virtual seat 326 as shown in FIG. 3A. The virtual seat assignment is optionally automatically determined upon initiation of the communication session, and/or can be dynamically assigned as one or more users join the communication session, optionally resulting in the arrangement shown in FIG. 3A.

In some examples, the virtual seating arrangement includes the quantity, position, and/or orientation of virtual seats. In some examples, the virtual seating arrangement includes the assignment of users to virtual seats and/or a lack of assignment of one or more users to one or more virtual seats, and/or vice-versa. In some examples, the virtual seating arrangement includes the spatial distribution of the virtual seats relative to each other and/or shared virtual content.

In some examples, electronic device 101 detects input requesting display of information about users in the communication session and/or relating to seats in the virtual seating arrangement. For example, in FIG. 3A, electronic device 101 detects an input performed by hand 322, including an air pinching gesture. The air pinch gesture can include contacting of two or more fingers of hand 322 of user 328.

In some examples, electronic device 101 detects additional or alternative inputs. For example, electronic device 101 can detect an air gesture including moving, contacting, maintaining of position, changing of a spatial arrangement between fingers, hands, and/or other body parts moving within the physical environment. As examples, the air gesture can include an air separating of one or more fingers, and air curling of one or more fingers, an air pointing of one or more fingers, and air posing of one or more hands and/or fingers in a predetermined pose (e.g., a nearly pinched pair of fingers, a fully extended set of fingers, and/or a resting of one or more fingers on a palm of a hand).

In some examples, the additional or alternative inputs include input directed toward a peripheral device in communication with electronic device 101. For example, the peripheral device can be a stylus, an electronic pointing device, a trackpad, a glove, a thimble, a ring, a controller, and/or some combination of such devices. In some examples, the one or more inputs can include contacting with a housing of the peripheral device, pressing of a button on the peripheral device, contacting with a trackpad of the device, pointing of the peripheral device toward a location that corresponds to virtual content relative to the viewpoint of electronic device 101, a voice command, movement of the peripheral device, and/or some combination thereof. For example, electronic device 101 can directly detect and/or detect an indication of a pressing of a button or a contacting and/or moving of the contact on a housing of an oblong electronic pointing device (e.g., while an end of the pointing device is pointed toward the avatar 308). In response to detecting the input and/or the indication, electronic device 101 can perform one or more operations that are described with reference to air pinches and/or air gestures performed by hand 322 described herein. Additionally or alternatively, electronic device 101 can display a cursor that overlays a position in three-dimensional environment 302 corresponding to a target of gaze of a user and/or corresponding to a location that is expressly specified (e.g., by moving of a contact on a trackpad and/or moving of a joystick) by a peripheral controller device. While the cursor overlays avatar 308, electronic device 101 can detect an input and/or an indication of an input from the controller indicating selection (e.g., pressing of a button, one or more successive and/or concurrent contacts with the housing and/or with the trackpad, and/or a voice command). In response to detecting the input and/or the indication, electronic device 101 can perform one or more operations that are described with reference to air pinches performed by hand 322 described herein.

It is understood that input provided by hand 322 is described as an air pinch gesture as described with reference to FIG. 3A, but such input is merely one of many possible examples. For example, electronic device 101 detects one or more of the air pinch, the pressing of a button at a pointing device, and/or the contacting of a trackpad at a controller. In response to detecting the one or more aforementioned inputs, electronic device 101 optionally initiates the operations described with reference to FIG. 3B. In some examples, the operations include requesting display of information about users in the communication session and/or relating to seats in the virtual seating arrangement.

In some examples, electronic device 101 displays information identifying avatars and/or visually indicating a location of users and/or avatars relative to virtual seats shared in the communication session. For example, from FIG. 3A to FIG. 3B, electronic device 101 displays the visual indications 324 and 305 in response to detecting the air pinch input performed by hand 322 as shown in FIG. 3A. Further, electronic device 101 moves avatar 308 relative to three-dimensional environment 302 in response to detecting an indication of movement of a viewpoint of the second user corresponding to avatar 308 from FIG. 3A to FIG. 3B.

Visual indication 324 can correspond to a virtual shadow overlaying a virtual floor of the virtual environment in three-dimensional environment 302. The virtual shadow can be virtually cast based on the position and/or orientation of avatar 308 relative to the virtual environment, such as based upon one or more simulated light sources directed overhead of avatar 308. For example, as avatar 308 moves relative to the virtual environment and/or three-dimensional environment 302, electronic device 101 can move the visual indication 324 in one or more directions and/or by one or more distances corresponding to (e.g., the same as) the movement of avatar 308. In some examples, the virtual shadow can be between a corresponding virtual avatar and a floor of three-dimensional environment 302. In some examples, the virtual shadow can be offset from the floor of three-dimensional environment 302.

As described above with respect to the communication session, electronic device 101 and the second and/or third electronic devices can transmit and/or receive data and/or other information to indicate a location and/or movement of viewpoints of respective users of the electronic devices relative to their respective three-dimensional environments. For example, from FIG. 3A to FIG. 3B, electronic device 101 can receive information from the second electronic device that the viewpoint of the second electronic device moved relative to a second three-dimensional environment (e.g., different from three-dimensional environment 302 with respect to a physical environment) of the second electronic device. As one example, the viewpoint movement can include moving of the second user within the second three-dimensional environment, and the information can be indicative of an updated position, orientation, a speed and/or acceleration of the movement, and/or a distance of the movement of the second user. In response to receiving the information from the second electronic device, 101 can move avatar 308 relative to three-dimensional environment 302 and/or the virtual environment, similar to as though the second user were physically moving within the physical environment of user 328. Additionally or alternatively, electronic device 101 moves visual indication 324 from as shown in FIG. 3A to as shown in FIG. 3B concurrently with the movement of avatar 308.

Similarly, the third electronic device can receive the same or similar information indicative of the movement of the viewpoint of the second user, and can move a displayed avatar corresponding to avatar 308 relative to a third three-dimensional environment of the third user.

Thus, in real-time, or nearly in real-time, the electronic devices participating in the communication session can update the location and/or orientation of displayed visual representations of the other users. By facilitating real-time, or nearly real-time updating of locations and/or orientations of visual representations relative to a three-dimensional environment of an electronic device based upon movement of a viewpoint of other electronic devices that correspond to the visual representations, the electronic device can simulate the experience of sharing a physical space, reducing user inputs required to expressly move the visual representations, thereby reducing processing required by the electronic device to detect and perform operations based upon the user inputs.

In some examples, in response to detecting input such as shown in FIG. 3A, electronic device 101 can display a visual indication of a virtual seating arrangement. For example, by displaying virtual seat 330, electronic device 101 can indicate that avatar 308 is assigned to virtual seat 330 and/or that virtual seat 330 exists in the three-dimensional environment 302 and/or in the communication session. Virtual seat 330, as described above, can correspond to a second virtual seat, different from the first virtual seat of user 328 (e.g., different from virtual seat 303). Thus, as shown in FIG. 3B, electronic device 101 can display a location of a virtual seat, thereby illustrating a prospective target of a virtual seat swapping or exchanging operation. In some examples, virtual seat 330 is displayed with a border, color, fill pattern, simulated lighting, and/or some combination thereof within the three-dimensional environment 302.

As shown in FIG. 3B, visual indication 305 overlays a location corresponding to a third virtual seat 326, different from the first and the second virtual seats (e.g., different from virtual seats 303 and 330). In some examples, in response to detecting the input such as shown in FIG. 3A, and in accordance with a determination that an avatar corresponds to a virtual seat, electronic device 101 can display a visual indication to indicate the existence and/or location of the virtual seat. For example, electronic device 101 can display a border surrounding visual indication 305, indicating that virtual seat 326 exists, and that avatar 310 is currently located on virtual seat 326. Additionally or alternatively, electronic device 101 can change one or more visual characteristics of visual indication 305 (e.g., a level of opacity, a level of saturation, a brightness, a color, and/or a fill pattern) and/or can display information such as text and/or images overlaying visual indication 305.

As shown in FIG. 3B, electronic device 101 can detect input performed by hand 322 while attention 312 is directed toward avatar 308. In some examples, the input shown in FIG. 3B can alternatively be directed toward information 304, virtual seat 330, and/or visual indication 324. In response to detecting one or more of such inputs, electronic device 101 can initiate operation(s) to swap or exchange virtual seats, which can include updating the virtual seats the users are assigned to. As shown in FIG. 3B, the input directed toward avatar 308 and/or virtual seat 330 (e.g., the seat that avatar 308 is assigned to) is or includes a request to exchange assigned seating; in FIG. 3B, user 328 requests reassignment of the first electronic device (e.g., electronic device101) and/or user 328 to virtual seat 330, and requests reassignment of avatar 308 to virtual seat 303.

FIG. 3C illustrates an example of a completed virtual seat swap or exchange. In some examples, electronic device 101 displays virtual content shared in the communication session (and/or other virtual content not shared in the communication session) relative to a virtual seat that user 328 targets when completing a virtual seat swapping operation. For example, in response to detecting the input as shown in FIG. 3B, electronic device 101 exchanges the assigned virtual seating. In FIG. 3C, electronic device 101, user 328, and the viewpoint of electronic device 101 are assigned to the virtual seat 330. To reflect the updated seating assignment, electronic device 101 can update display of virtual content in response to detecting the input requesting the virtual seat swapping. For example, as shown in FIG. 3C, electronic device 101 displays the virtual content including virtual object 314, virtual seat 303, avatar 308, and visual indication 324 relative to the viewpoint of electronic device 101 seated at virtual seat 330. Thus, the position and/or orientation of shared virtual content such as virtual object 314 is updated, similar to as though electronic device 101 were physically moved to a physical equivalent of virtual seat 330, moved to a second end of the billiards table represented by virtual object 314.

In some examples, electronic device 101 displays visual feedback indicating that the virtual seat swapping is performed in response to detecting input requesting the virtual seat swapping. For example, electronic device 101 can display visual indication 334 as shown in FIG. 3C, which can include text, media, and/or animations indicating completion of the virtual seat exchange. In some examples, electronic device 101 can present additional or alternative feedback to convey that being assigned to a new virtual seat has changed the user's spatial arrangement with virtual content. For example, electronic device 101 can display a virtual glowing effect at locations that are generally toward or are precisely located where virtual seats exist. As an example, electronic device 101 can display a virtual glowing effect on a floor of three-dimensional environment 302 emanating from virtual seat 303. In some examples, displaying the virtual glowing effect includes displaying portions of three-dimensional environment 302 with a brightness, saturation, opacity, color and/or some combination thereof with value(s) such that the portions appear to illuminate or glow, especially relative to the visual appearance constituent value(s) of visual properties prior to displaying the virtual glowing effect.

In some examples, electronic device 101 displays the virtual glowing effect at a portion of a viewport that corresponds to virtual seats that are not displayed. For example, electronic device 101 in FIG. 3C is not displaying the virtual seat 326 (e.g., has forgone display of virtual seat 326 in response to detecting the input requesting the virtual seat swapping). To indicate that virtual seat 326 is relatively to a left-hand side of the viewpoint of electronic device 101 shown in FIG. 3C, electronic device 101 can display a simulated glowing effect at one or more portions left of a center of the viewport of electronic device 101 and/or left of a center of display120.

In some examples, electronic device 101 presents spatial audio corresponding to the location of the virtual seats. For example, in response to response to detecting the input requesting the virtual seat swapping, electronic device 101 can generate audio such as one or more tones, chords, arpeggios, and/or non-musical sound effects. In some examples, electronic device 101 applies one or more time delays, digital filters, and/or applies additional or alternative techniques to simulate the sensation of the audio being generated by point audio sources located at the virtual seats. For example, electronic device 101 in FIG. 3C can generate audio corresponding to virtual seat 303 that is configured with first one or more time delays between one or more channels of audio, such that the generated audio is a chime that sounds as though it emanates from virtual seat 303. Additionally or alternatively, concurrently or successively, electronic device 101 can generate different audio corresponding to virtual seat 326 with second one or more time delays between the one or more channels of audio, such that the generated audio is a different toned chime that sounds as though it emanates from virtual seat 326.

As described above, in some examples, the physical position and/or orientation of electronic device 101 is maintained before, during, and after performing virtual seat swapping operation(s). For example, from FIG. 3B to FIG. 3C, electronic device 101 does not move relative to the physical ceiling, floor, and/or walls visible in three-dimensional environment. Thus, the change in viewpoint of electronic device 101 relative to three-dimensional environment 302 can be due to the updated spatial arrangement between electronic device 101 and virtual content (e.g., virtual object 314 and/or virtual seat 303), and can be less due (or not due) to the spatial relationship between the viewpoint of electronic device 101 and the physical environment that is maintained from FIG. 3B to FIG. 3C.

In some examples, electronic device 101 resets a spatial arrangement between participants of the communication session in response to detecting user input. In some examples, the user input is a touch input (e.g., on a touch screen), a press and/or rotation of a physical button, an air gesture (e.g., an air pinch gesture or another gesture), a verbal request (e.g., detected using a microphone), a gaze direction (e.g., detected by an eye-tracking camera(s)), or another type of user input. In some examples, resetting the spatial arrangement includes setting or resetting the virtual locations for representations and/or for the viewpoints of users participating in the multi-user according to a template associated with the quantity of users participating in the multi-user. In some examples, displaying the representation of the second user at an initial virtual seat for the second user or an updated virtual for the second user includes moving the representation of the second user from a respective virtual location to the initial virtual or the updated virtual seat, such that the representation of the second user is displayed at a slot in a spatial template corresponding to the current quantity of participants.

In some examples, electronic device 101 detects user input requesting a virtual seat swap while a respective user assigned to a target virtual seat is at a location away from the targeted virtual seat. In some examples, the results of a virtual seat swap or exchange can include being assigned to the targeted seat. Additionally or alternatively, when performing the virtual seat swap, electronic device 101 can display the virtual content as though the viewpoint of electronic device 101 assumes the off-seat location and/or position of another user assigned to the targeted virtual seat. Thus, electronic device 101 can be assigned to a targeted virtual seat and can display the virtual content as though the viewpoint of the user is not located at the targeted virtual seat.

FIG. 3D illustrates an example of electronic device 101 detecting inputs requesting virtual seat swapping with avatar 308. For example, in FIG. 3D, electronic device 101 detects hand 322 perform an air pinch gesture while attention 307 and/or 332 directed toward avatar 308 and/or information 304. In some examples, the inputs have one or more characteristics similar to, or the same as those described with reference to air gesture(s), peripheral device(s), and/or the like herein.

From FIG. 3D to FIG. 3E, electronic device 101 performs the virtual seat swapping and/or exchanging operation(s), which include assigning virtual seats and assuming the virtual perspective of an off-seat location of a user (e.g., a location of avatar 308 that is away from virtual seat 330).

From FIG. 3D to FIG. 3E, electronic device 101 updates the virtual seating arrangement and/or updates display of the virtual content in response to detecting the input shown in FIG. 3D. As described above, in some examples, electronic device 101 reassigns the virtual seating arrangement in accordance with the seat swapping requests. For example, in FIG. 3E, electronic device 101 and user 328 are assigned to virtual seat 330, and a second electronic device corresponding to avatar 308 is assigned to virtual seat 303 in response to detecting the input illustrated in FIG. 3D.

As described above, in some examples, in response to detecting the input requesting the virtual seat swapping, electronic device 101 displays virtual content that corresponds to a viewpoint (e.g., location and/or orientation) of a user assigned to a virtual seat that was targeted by the virtual seat swapping input. Described an additional way, the spatial arrangement between user 328 and virtual object 314 can be the same as a spatial arrangement between avatar 308 and virtual object as shown in the overhead view of three-dimensional environment 302 in FIG. 3D. As described above, electronic device 101 can be assigned to virtual seat 330, but the virtual content shared in the communication session can be displayed relative to the location of electronic device 101 that is away from virtual seat 330 in FIG. 3E. In some examples, the spatial arrangement of virtual content is “recentered” as described further herein to correspond to a center of the user's viewpoint. For example, electronic device 101 in FIG. 3E is located and oriented relative to the virtual environment with a location and orientation that is the same as avatar 308 in FIG. 3D. Consequentially, in response to detecting the input requesting the virtual seat swapping, electronic device 101 displays virtual object 314 as though located on a side of the billiards table included in virtual object 314, facing toward virtual seat 303, as shown in FIG. 3E.

Thus, in response to detecting an input requesting a virtual seat swapping, electronic device 101 can update a virtual seating arrangement associated with the communication session. In some examples, the update can include exchanging or swapping the seat that user 328 is assigned to with another seat that is assigned to another user of another device participating in the communication session. In some examples, in response to detecting the input, electronic device 101 displays the virtual content with an updated spatial arrangement. In some examples, the updated spatial arrangement corresponds to the spatial relationship between the newly assigned virtual seat and the virtual content. In some examples, the updated spatial arrangement corresponds to the spatial relationship between the viewpoint of a user targeted in accordance with the virtual seat swap request (e.g., that previously was assigned to the targeted virtual seat) and the virtual content.

It is understood that the examples described with reference to FIGS. 3A through 3E are merely exemplary, and can be repeated, substituted, and/or the like in accordance with different inputs, different targets of the inputs, different virtual content, different virtual seating arrangements, and/or the like. For example, electronic device 101 can detect input such as an air pinch provided by hand 322 while attention is directed to avatar 310, and in response, can perform virtual seat swapping similar as described above, but relative to the virtual seat 326 and/or avatar 310. In such an example, electronic device 101 can forgo virtual seat swapping between user 328 and avatar 308, because avatar 308 and/or virtual seat 330 is not a target of the virtual seat swapping operation.

In some examples, virtual seat swapping is contingent upon approval of a target of the virtual seat swapping operations. For example, as described with reference to FIG. 3J, electronic device 101 receives a request to exchange seats (e.g., from the second user or the third user), and can display a prompt to approve or reject the swapping. In such an example, electronic device 101 can transmit an indication of the approval or rejection to the communication session. In response to receiving the indication of the approval, electronic device 101 and/or other electronic devices involved in the virtual seat swapping can initiate the virtual seat swapping operations described above. In some examples, in response to detecting input rejecting the virtual seat swapping request, electronic device 101 (and/or other electronic devices) can forgo performing of the virtual seat swapping operations.

Similarly, virtual seat swapping from the perspective of electronic device 101 can be approved or rejected by a targeted user. For example, electronic device 101 can transmit a request to approve the virtual seat swapping in response to an input such as shown in FIG. 3B and can optionally forgo performing the virtual seat swapping (e.g., forgo displaying virtual content as shown in FIG. 3C) in accordance with a determination that the second user corresponding to avatar 308 rejects the request. Additionally or alternatively, the virtual seat swapping can be performed in accordance with a determination that the second user approves the request.

It is understood that the electronic device 101 and/or the other electronic devices participating in the communication session can perform some or all of the operations described above, potentially without limitation. For example, electronic device 101 can repeatedly request a series of virtual seat swaps, and can successively perform the virtual seat swaps. Additionally or alternatively, electronic device 101 can perform a virtual seat swap with a vacant seat (e.g., no device and/or user is assigned to that seat). In such an example, electronic device 101 can reassign the targeted, previously vacant seat to user 328, and leave the previous seat of user 328 vacant.

FIGS. 3F through 3N illustrate examples in which electronic device 101 facilitates virtual seat swapping or exchanging associated with a different spatial template than as shown in FIGS. 3A through 3E. In some examples, the spatial template can correspond to a presentation template, in which a presenter user is oriented toward one or more audience users and can include shared virtual content that the presenter is able to interact with. In some examples, electronic device 101 recenters virtual content, including the visual representations of users, such as avatars of the users. In some examples, the recentering is performed in response to detecting input(s) requesting virtual seat swapping. In some examples, the recentering is performed in response to detecting additional or alternative input(s). In some examples, electronic device 101 displays visual indications that other users in the communication session are performing virtual seat swapping, and updates the displayed virtual seating arrangement in accordance with the activity from other users. In some examples, electronic device 101 facilitates virtual seat swapping by displaying an interactive view of a virtual seating arrangement. In some examples, electronic device 101 allows, or does not allow, virtual seat swapping in accordance with a role associated with a user within the virtual seating arrangement.

FIG. 3F illustrates a presentation template virtual seating arrangement. For example, three-dimensional environment 302 in FIG. 3F includes physical portions of the physical environment (e.g., physical window 336) visible by reproduction via one or more image sensors 114a-114c and/or visible via an at least partially transparent material. Three-dimensional environment 302 in FIG. 3F additionally includes virtual content 340 that is shared in a communication session with users corresponding to avatar 308, avatar 310 (shown in the top-down view), avatar 348 (shown in the top-down view), avatar 350 (shown in the top-down view), and avatar 352 (shown in the top-down view). Virtual content 340 can correspond to a virtual object that includes a user interface for viewing and/or interacting via the communication session, such as a presentation user interface for an application used to present a slide deck. As shown in FIG. 3F, virtual content 340 is shared in the communication session, indicated by visual indication 338, and users in the communication session are able to move virtual content 340 by interacting with grabber 356 associated with the virtual content 340. In some examples, a “grabber” is a selectable option that when selected, initiates movement of at least the corresponding virtual content.

As illustrated in the top-down view of three-dimensional environment 302 (e.g., “Top-Down View”), electronic device 101 is oriented at a center of an arc of users. As shown in FIG. 3F, the spatial arrangement of virtual content and users includes a virtual seating arrangement which includes the arc, and further includes a presenter seat (e.g., occupied by avatar 308). In FIG. 3F, avatar 308 is assigned to the presenter seat, which underlays the visual indication 342. As described further herein, in some examples, electronic device 101 permits virtual seat swapping with a virtual seat that satisfies one or more criteria, such as a criterion satisfied that when the virtual seat corresponds to a first role (and/or does not correspond to a second type of role).

In some examples, virtual seats are associated with roles. In some examples, the roles are associated with and/or define a set of permitted interactions with the communication session available to users assigned to those roles and/or virtual seats. In some examples, the roles include one or more of: an audience member, a presenter, a game player, an observer, a performer, a coach, an adjudicator, and/or a moderator.

As an example, the virtual seats illustrated in FIGS. 3A through 3E can be associated with game player roles. In such an example, the users can sequentially interact with the virtual billiards table. In some examples, the virtual seats include a game observer, which is not able to interact with the virtual billiards table. As shown in FIG. 3F, electronic device 101 and/or other avatars can be assigned virtual seats that correspond to audience member roles. Accordingly, electronic device 101 can restrict (e.g., forgo) performing operations interacting with virtual content 340, such as moving virtual content while the second user corresponding to avatar 308 is speaking and/or changing respective content included in virtual content 340. In contrast, while avatar 308 is assigned to the presenter virtual seat, the second electronic device corresponding to avatar 308 can detect inputs directed toward virtual content 340, and can perform operations that are not permitted by electronic device 101 (e.g., at least temporarily not permitted), such as advancing a presentation slide.

In some examples, restrictions relating to roles associated with a virtual seat include the ability to perform a virtual seat swap. For example, in FIG. 3F, electronic device 101 detects input performed by hand 322 (e.g., an air pinch) while attention 344 is directed to avatar 308. From FIG. 3F to FIG. 3G, electronic device 101 forgoes performing of a virtual seat swap. In some examples, electronic device 101 forgoes the virtual seat swap because the presenter role at least temporarily restricts virtual seat swapping. For example, any electronic device that corresponds to avatars 310 and/or 348 through 352 can forgo performing of the virtual seat swap while the avatar 308 is providing voice input, and/or before a position within a slide deck included in virtual content 340 is before a threshold position in the slide deck presentation. For example, electronic device 101 can forgo virtual seat swapping before the presentation has concluded, and/or before reaching a slide prompting the audience for interaction and/or questions. By permitting or restricting operations based on the roles assigned to a virtual seat, electronic device 101 may control the operations that electronic device 101 may perform based on the role, thereby potentially suppressing performing of operations.

In some examples, electronic device 101 displays virtual content based upon the viewpoint of electronic device 101 relative to three-dimensional environment 302. For example, from FIG. 3G to FIG. 3H, electronic device 101 detects movement of the user physically rotating relative to three-dimensional environment 302, and in response, initiates and/or ceases display of virtual content that does or does not correspond to the rotated viewpoint. For example, in FIG. 3H, electronic device 101 initiates display of avatar 310 and avatar 348, which can be concurrently displayed with information 346. Additionally, electronic device 101 initiates display of visual indication 354, which overlays a virtual seat corresponding to avatar 310. In FIG. 3H, electronic device 101 ceases display of avatar 308 and/or virtual content 340 in response to detecting the rotation of the viewpoint, because the rotated viewpoint is oriented away from such virtual content.

In some examples, electronic device 101 permits virtual seat swapping with virtual seats that do not satisfy the one or more criteria. For example, in FIG. 3H, electronic device 101 detects an air pinch input performed by hand 322 while attention is directed toward avatar 310. Because avatar 310 is assigned to a virtual seat that is not a presenter seat and/or is an audience member role, electronic device 101 can facilitate virtual seat swapping with avatar 310.

For example, from FIG. 3H to FIG. 3I, electronic device 101 changes the seat that is assigned to electronic device 101 in accordance with the virtual seat swapping input requested as shown in FIG. 3H. In FIG. 3I, as illustrated in the top-down view, electronic device 101 is assigned to a leftmost virtual seat relative to the side of the arc facing toward virtual content 340. Further, avatar 310 is reassigned to the center virtual seat (e.g., that user 328 occupied in FIG. 3H).

As described above, electronic device 101 can display virtual content, recentering the virtual content with the viewpoint of the electronic device 101, in response to input(s) such as input(s) requesting virtual seat swapping. As shown in FIG. 3I, electronic device 101 updates the spatial arrangement in accordance with the updated virtual seating assignment; virtual content 340 and avatar 308 are displayed with an updated position and orientation relative to the viewpoint of the user (e.g., relative to a center of the virtual seat). In FIG. 3I, electronic device 101 detects input while attention 358 is directed toward grabber 356, and in response to detecting the input, initiates movement of virtual content 340.

From FIG. 3I to FIG. 3J, electronic device 101 detects movement of hand 322 while the air pinch shown in FIG. 3I is maintained, and in response, moves virtual content 340 relative to three-dimensional environment 302. For example, in FIG. 3J, electronic device 101 moves virtual content to be virtually pinned (e.g., world-locked) within three-dimensional environment 302, parallel to the physical wall included in three-dimensional environment 302. In some examples, electronic device 101 moves virtual content to correspond to physical features in three-dimensional environment 302, such as along a physical wall and/or sitting on top a physical table. In such examples, electronic device 101 can maintain the position of the virtual object as though coupled to the physical object. In some examples, while the virtual object is world-locked as described previously, electronic device 101 forgoes movement of the virtual object (e.g., in response to detecting an input recentering virtual content and/or requesting a virtual seat swap).

In FIG. 3J, electronic device 101 detects an input including an air pinch performed by hand 322 while attention 366 is directed toward menu 360. Menu 360 can include a prompt to approve or reject a request to exchange seats. For example, menu 360 can be displayed in response to receiving an indication of an input requesting virtual seat swapping with electronic device 101 (e.g., by the electronic device corresponding to “George”). In some examples, electronic device 101 can approve or reject the virtual seat swapping request and can perform or forgo performing of the virtual seat swap in accordance with input directed toward menu 360.

Specifically, in FIG. 3J, attention 366 is directed to selectable option 362 (e.g., “Yes”) which when selected can approve the request. In contrast, selectable option 364 can be included in menu 360, and can be selected to reject the request and forgo the virtual seat swapping. In FIG. 3J, electronic device 101 detects the air pinch performed by hand 322, thereby approving the virtual seat swapping.

In FIG. 3K, electronic device 101 updates display of avatar 308 in accordance with the updated assignment relative to the virtual seating arrangement. For example, as shown in the top-down view of three-dimensional environment 302, electronic device 101 corresponds to a right end of the side of the arc of audience role virtual seats oriented toward avatar 308. Virtual content 340, however, is not moved (e.g., electronic device 101 forgoes updating the position and/or orientation of virtual content 340), because virtual content 340 is world-locked in accordance with previous input provided by user 328. As shown in the overhead view, avatar 352 is reassigned to the leftmost seat in the arc virtual seating arrangement due to the virtual seat swapping, corresponding to the virtual seat that user 328 vacated while performing the virtual seat swapping.

In FIG. 3L, electronic device 101 receives an indication that other users in the communication session have swapped virtual seats as the electronic device 101 changes to view the result of the virtual seat swapping. For example, FIG. 3K to FIG. 3L, electronic device 101 detects movement rotating the viewpoint leftward, such that the virtual seat occupied by avatar 352 is visible. As described above, participants (e.g., users of electronic devices) participating in the communication session are capable of requesting and/or performing virtual seat swapping, and indicating updates to the virtual seating arrangement in accordance with the virtual seat swapping. In response to receiving an indication from electronic devices in the communication session (e.g., corresponding to “Anne” and “Betty”), electronic device 101 displays notification 368, which includes text describing the users involved in the virtual seat swapping operation (e.g., “Anne and Betty swapped seats”). As shown in the overhead view from FIG. 3K to FIG. 3L, avatars 310 and 348 exchange virtual seats while the arrangement of virtual seats is otherwise maintained. Thus, similar to as described with reference to virtual seat swapping initiated by electronic device 101, electronic devices corresponding to avatars 310 and 348 can facilitate virtual seat swapping, updating display of shared virtual content, and/or the like in response to inputs requesting and/or approving the virtual seat swapping.

In some examples, electronic device 101 displays an interactive view of a virtual seating assignment. For example, electronic device 101 detects an input, such as a voice command requesting display of the view of the virtual seating assignment. In response to detecting the input, electronic device 101 can display a view 370 of the virtual seating arrangement. In some examples, the view 370 includes a diagrammatic view of the virtual seating assignment, including representations of the users of the communication session. In some examples, view 370 visually indicates the virtual seat assigned to user 328. For example, visual representation 374 corresponds to user 328, and is displayed with one or more visual characteristics, differentiating visual representation 374 from other representations of users in the virtual seating arrangement. For example, visual representation 376 can correspond to avatar 308. In some examples, electronic device 101 facilitates virtual seat swapping based upon interactions with the interactive view 370, such as input including an air pinch formed by hand 322 while attention 372 is directed to visual representation 376 in FIG. 3M.

From FIG. 3M to FIG. 3N, electronic device 101 updates the virtual seating arrangement in accordance with the input shown in FIG. 3M. For example, electronic device 101 can assume the virtual seat corresponding to the presenter role, which can face toward the arc of virtual seats corresponding to audience member roles. For example, electronic device 101 displays avatars 308 and 310, and 348 through 352, in response to detecting the input shown in FIG. 3M. In some examples, the updated virtual seating arrangement shown in FIG. 3N is additionally or alternatively displayed in response to detecting input directed toward avatar 308 when displayed as shown in FIG. 3M. For example, electronic device 101 can detect an air pinch while attention is directed toward avatar 308 as shown in FIG. 3M, and in response, can update the virtual seating arrangement and display virtual content as shown in FIG. 3N.

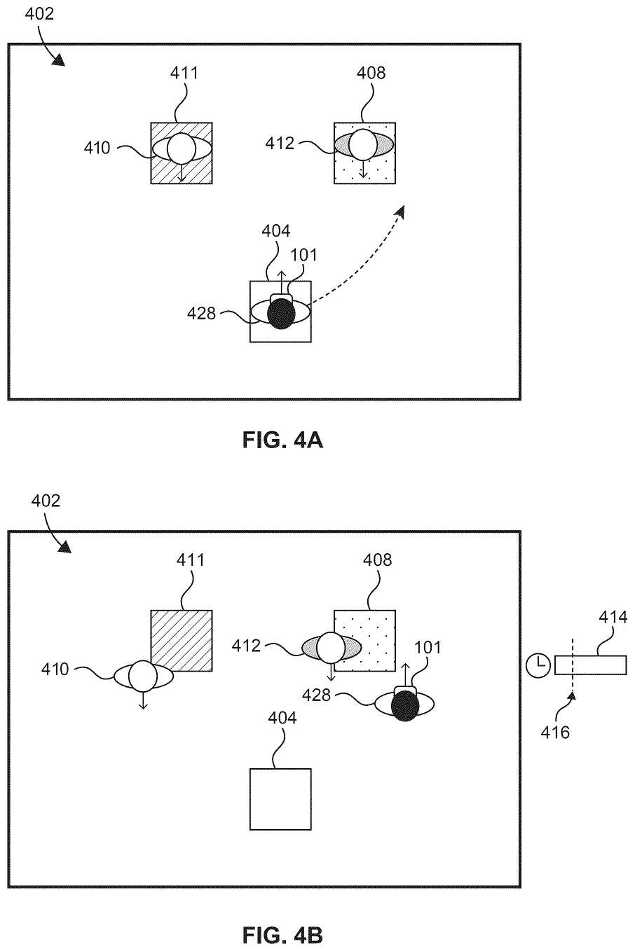

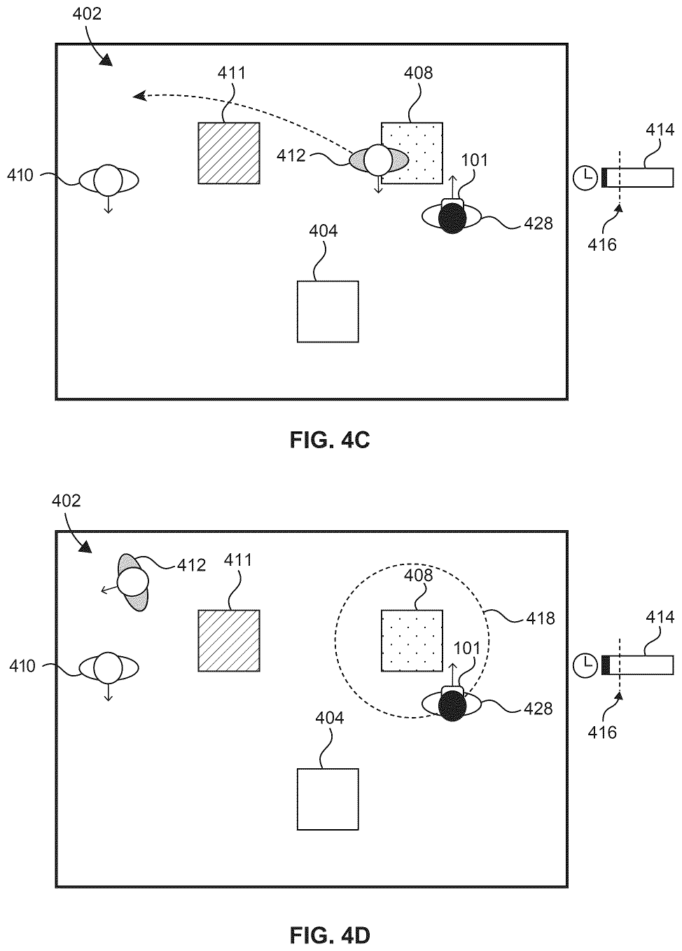

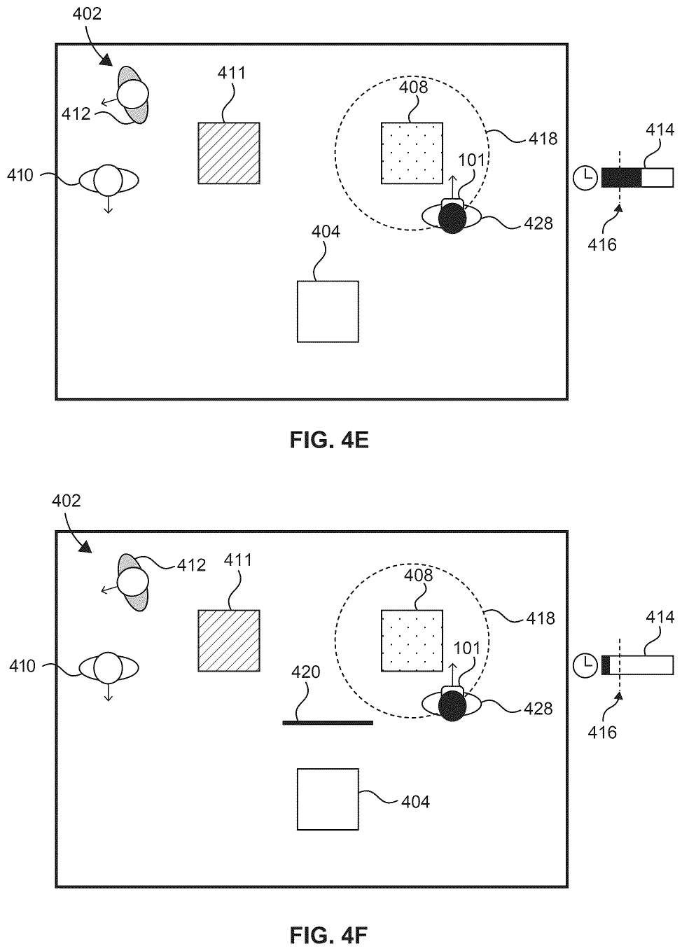

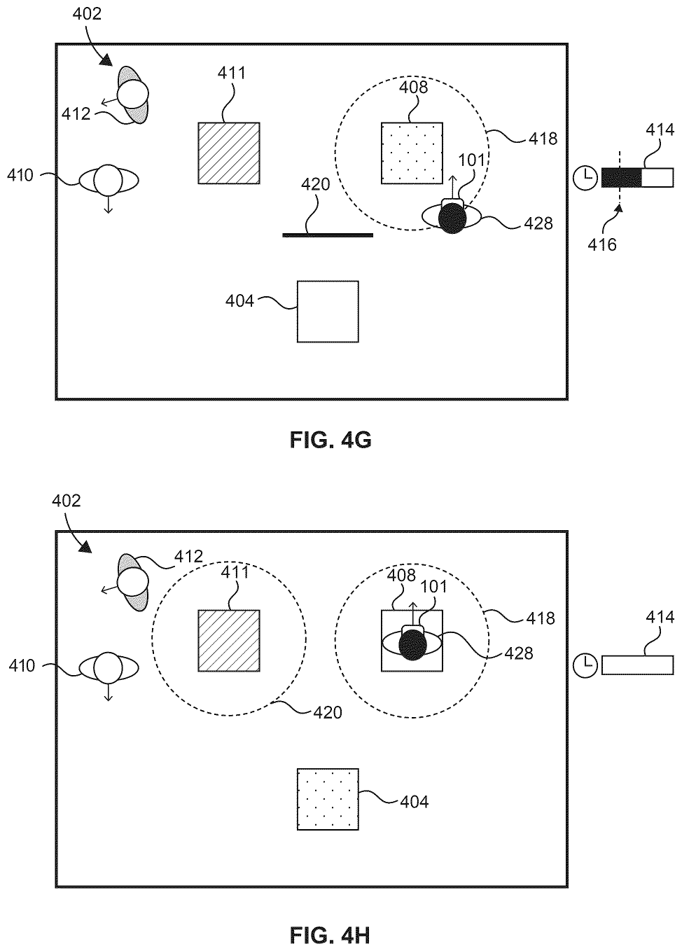

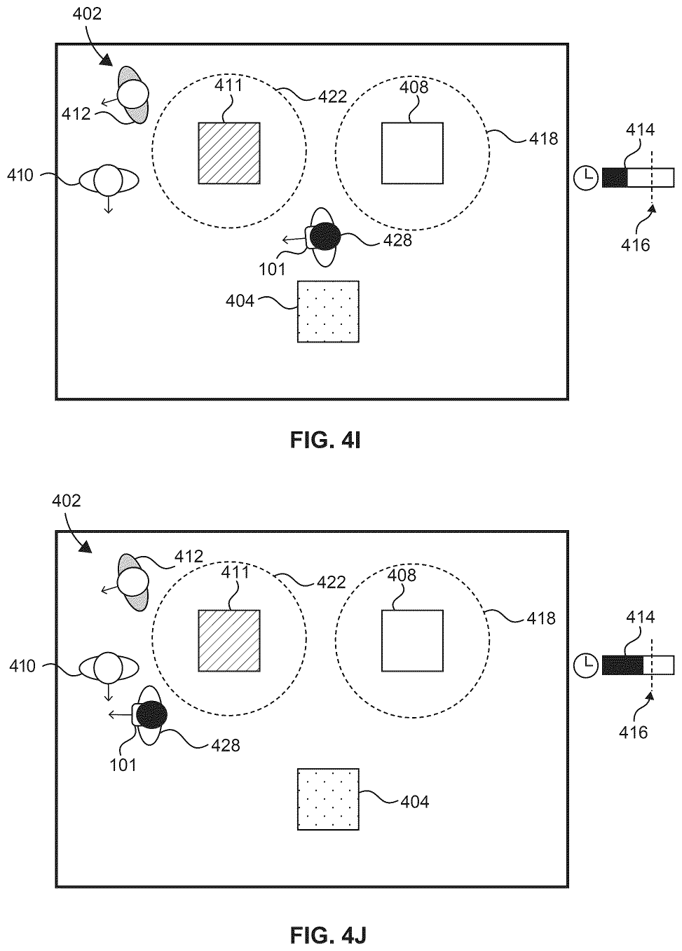

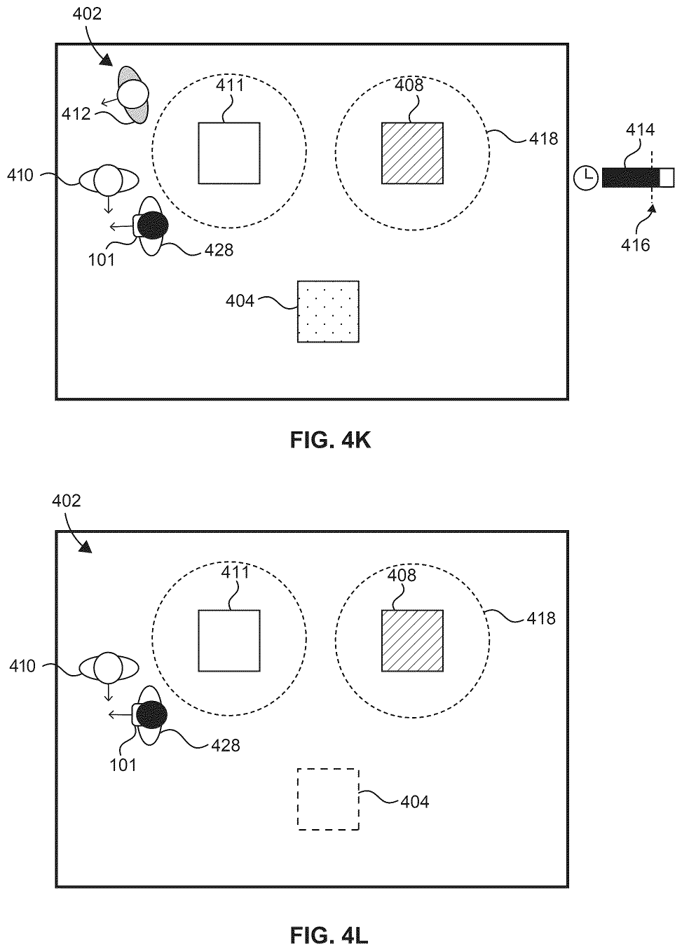

In addition to, or in the alternative to, the examples described with reference to FIGS. 3A-3N, electronic device 101 can additionally or alternatively perform one or operations described with reference to FIGS. 4A-4L. In some examples, the operations include an implicit and/or express requesting of virtual seats, and a reassignment of electronic devices and/or users in accordance with the requests (e.g., initiation of a new assignment, and ceasing of a previous assignment). Thus, broadly speaking, electronic device 101 can detect interactions with a three-dimensional environment and/or a virtual seat, and can update the virtual seating arrangement in accordance with the interaction. In some examples, the interaction is detected at a first time, and at a later time (e.g., automatically, and/or not immediately in response to the detected interaction) electronic device 101 updates the virtual seating arrangement. In some examples, the interaction includes moving toward or away from virtual seats. In some examples, the interaction includes leaving a virtual seat for a period of time greater than a threshold period of time. In some examples, electronic device 101 forgoes updating the virtual seating arrangement when the virtual seating arrangement and/or the three-dimensional environment 402 includes certain characteristics. In some examples, electronic device 101 resolves competing requests to perform virtual seat swaps. In some examples, electronic device 101 changes or maintains at least some or all of a virtual seating arrangement in response to detecting user(s) enter or exit a multi-user communication session. These and other examples are described further herein. By facilitating a virtual seat swapping that may not be immediately predicated on user input, an electronic device 101 may change the roles, permitted operations, and/or the manner by which virtual seats are reassigned, potentially reducing the amount of user input required to manually request the swapping of seats. In this way, electronic device 101 may reduce processing required to detect such inputs, and may improve the efficiency of interactions and/or management of assignments to the virtual seats while engaged in a multi-user communication session.

In some examples, electronic device 101 is located within a three-dimensional environment 402. In some examples, three-dimensional environment 402 has one or more characteristics similar to, or the same as, the three-dimensional environment described with reference to FIGS. 3A-3N. For example, three-dimensional environment 402 includes a plurality of users participating in a multi-user communication session in which information is exchanged to simulate physical co-location of the plurality of users. User 428, for example, can be a first user of electronic device 101 (e.g., a first electronic device). Avatar 410 can be a second user of the multi-user communication session that uses a second electronic device, different from electronic device 101, to participate in the communication session. Similarly, avatar 412 can be a third user of the multi-user communication session that uses a third electronic device, different from electronic device 101 and the second electronic device, to participate in the communication session.

As described with reference to FIGS. 3A-3N, avatars 410 and 412 can be or be included in visual representations of users of the multi-user communication session. It is understood that avatars 410 and 412 can have one or more characteristics similar to, or the same as, avatars described with reference to FIGS. 3A-3N. It is further understood that the avatars can be presented (e.g., displayed and/or visible via an at least partially passive and/or transparent material) via display 120.

Turning back toward three-dimensional environment 402, as shown in FIG. 4A, three-dimensional environment 402 includes and/or is presented according to a spatial template and/or a virtual seating arrangement. As illustrated in the top-down view of three-dimensional environment 402 in FIG. 4A, electronic device 101 and user 428 can be assigned to a first virtual seat 404. Similarly, avatar 410 can be assigned to a second virtual seat 411, and avatar 412 can be assigned to a third virtual seat 408. It is understood that the fill patterns illustrated in FIG. 4A illustrate the assignment of users to respective virtual seats. For example, virtual seat 404 includes a solid white fill pattern, virtual seat 411 includes a striped fill pattern, and virtual seat 408 includes a dotted fill pattern, indicating assignment to user 428, avatar 410, and avatar 412, respectively, and may not be displayed as virtual elements in the three-dimensional environment 402 by the electronic device 101.

In some examples, the virtual seats described with reference to FIGS. 4A-4L have one or more characteristics that are similar to, or the same as, virtual seats described with reference to FIGS. 3A-3N. For example, the virtual seats 408, 411, and 404 can have a spatial relationship relative to each other and/or to three-dimensional environment 402. In some examples, the position and/or orientation of the virtual seats can define how virtual content is displayed when a user returns to their assigned virtual seat, as described with reference to FIGS. 3A-3N. In FIG. 4A, a dashed arrow indicates a future movement of electronic device 101 relative to three-dimensional environment 402.

From FIG. 4A to FIG. 4B, electronic device 101 detects input requesting and/or corresponding to movement of electronic device 101 relative to three-dimensional environment 402. Thus, electronic device 101 detects an interaction with three-dimensional environment 402 and/or with the virtual seating arrangement. In FIG. 4B, after detecting the interaction that includes movement of the electronic device 101 relative to the three-dimensional environment 402, the viewpoint of electronic device 101 is positioned near virtual seat 408. In some examples, when the viewpoint of the user is within a threshold distance of a virtual seat, electronic device 101 and/or electronic devices in the communication session can potentially initiate reassignment of virtual seats. As shown in FIG. 4B, however, timer 414—indicating a dwell time that the viewpoint of electronic device 101 remains within a threshold distance (e.g., 0.5, 1, 1.25, 1.5, 1.75, 2, 2.5, 3, or 5 m) of virtual seat 408—has not been initiated because, in some examples, the reassignment of virtual seats is contingent upon availability of the virtual seat. Additionally or alternatively, the dwell timer can be initiated in response to detecting a user assigned to a virtual seat move to a location that is not within a region bound by the virtual seat, as shown in FIG. 4C. For example, as shown in FIG. 4C, the dwell timer 414 can be initiated when a user assigned to a virtual seat moves beyond the threshold distance of the virtual seat and/or moves off of the virtual seat.

From FIG. 4B to FIG. 4C, electronic device 101 detects an indication of movement of avatar 412 beyond threshold 418 of virtual seat 404 (e.g., shown in FIG. 4D). In response to detecting the indication, electronic device 101 can initiate the dwell timer 414, as shown in FIG. 4C. As indicated by the fill pattern occupying virtual seat 408, virtual seat 408 remains assigned to avatar 412 (e.g., assigned to the use represented by the avatar 412), because dwell timer 414 has not exceeded threshold 416. Thus, in some examples, electronic device 101 forgoes immediately assigning of a virtual seat in response to detecting an interaction such as movement of a viewpoint of electronic device 101 relative to a virtual seat. Stated an additional way, in accordance with a determination that one or more criteria are not satisfied, such as a criterion that is satisfied when a respective user assigned to a respective virtual seat is overlapping and/or within a threshold distance of said virtual seat, electronic device 101 can forgo reassignment of the virtual seat to user 428.

From FIG. 4C to FIG. 4D, electronic device 101 detects an indication of movement of avatar 412 away from virtual seat 408. Accordingly, dwell timer 414 continues to advance as shown in FIG. 4D. In FIG. 4D, in accordance with a determination that the one or more criteria are satisfied (e.g., avatar 412 does not overlap and/or is not within a threshold 418 distance of virtual seat 408), electronic device 101 is able to potentially reassign virtual seat 408 to user 428 and/or electronic device 101. In FIG. 4D, however, electronic device 101 has not reassigned virtual seat 408 (e.g., because dwell timer 414 has not exceeded threshold 416).

From FIG. 4D to FIG. 4E, electronic device 101 detects the viewpoint of electronic device 101 remain within threshold 418 for a period of time indicated by dwell timer 414 that is greater than threshold 416. In response to detecting dwell timer 414 exceed threshold 416, electronic device 101 can reassign the virtual seat 408 to user 428, indicated by the solid white fill pattern within virtual seat 408 in FIG. 4E. Additionally or alternatively, as shown in FIG. 4E, virtual seat 408 is reassigned to avatar 412, as indicated by the dotted pattern in virtual seat 408.

Thus, in some examples, electronic device 101 can reassign virtual seats without detecting an input corresponding to an express request to reassign the virtual seats, and/or can automatically reassign the virtual seats at a time after an interaction with three-dimensional environment 402 and/or a virtual seat is detected. For example, the movement of electronic device 101 from as shown in FIG. 4A to as shown in FIG. 4B can be different from an input expressly requesting a virtual seat swapping (e.g., as described with reference to FIGS. 3A-3N), such as an air pinch while attention is directed toward the virtual seat. Therefore, without requiring additional processing associated with the air pinch or other express input, electronic device 101 can perform a virtual seat swapping operation, thereby reducing power consumption and processing required to detect the express input. Additionally, the virtual seat swapping scheme described herein can provide a more flexible virtual seating arrangement, allowing users to more freely exchange virtual seats, and reducing potential disorienting of users of electronic devices when they return to virtual seats that are in a different portion of three-dimensional environment 402 than they currently occupy.

It is understood that the interaction with three-dimensional environment 402 and/or virtual seat 408 can additionally or alternatively be different from moving within a threshold distance of virtual seat 408. For example, the interaction can include staring toward (e.g., directing user gaze toward) a displayed virtual affordance, such as a button labeled “swap” for a period of time greater than a threshold period of time (e.g., 0.5, 1, 1.5, 3, 5, or 10 seconds).

Additionally or alternatively, the interaction can include a voice command requesting exchanging of the virtual seat at a later time, and/or an expressed preference to assume the virtual seat when the user assigned to the virtual seat moves beyond a threshold distance (e.g., threshold 418) from the virtual seat.

In some examples, electronic device 101 reassigns the virtual seat after a delay period that comes after an interaction is detected. For example, electronic device 101 can detect an air pinch while attention is directed toward a virtual seat; in response to detecting the air pinch, and in accordance with a determination one or more criteria are not satisfied, electronic device 101 can forgo the requested reassignment. In accordance with a determination that the one or more criteria are satisfied at a later time, electronic device 101 can perform the virtual seat swapping, optionally without detecting intervening inputs expressly requesting the virtual seat swapping a second time. For example, electronic device 101 can detect the air pinch, and can wait to perform the reassignment until a user that occupied the requested virtual seat exits the communication session and/or leaves the virtual seat (e.g., moves outside a threshold distance of a position corresponding to the virtual seat).

In some examples, electronic device 101 reassigns the virtual seat in accordance with a determination that a virtual seat swap was previously requested, and the requester of the virtual seat swap has moved away from their most recently assigned virtual seat. For example, electronic device 101 can detect a request to perform a virtual seat swap and can approve the virtual seat swap (e.g., exchanging assignment of virtual seat 404 with assignment of a user to virtual seat 408). In response to detecting that the viewpoint of the electronic device that requested the virtual seat swap is away from the virtual seat (e.g., beyond the threshold distance, and/or remains beyond the threshold distance for a period of time greater than a threshold period of time (e.g., 0.5, 1, 1.25, 1.5, 2, 2.5, 3, or 5 seconds), electronic device 101 reverts to the previous virtual seat swapping (e.g., reassigning electronic device 101 back to virtual seat 404, and reassigning the requestor user back to virtual seat 408).

As described with reference to FIGS. 3A-3N, electronic device 101 can detect an input requesting a return of users of the multi-user communication to their virtual seats and/or display of virtual content shared via the communication session relative to a virtual seat assigned to electronic device 101. For example, electronic device 101 can detect an input requesting display of virtual content relative to virtual seat 408 (e.g., while user 428 is assigned to virtual seat 408 as shown in FIG. 4E). In some examples, the spatial arrangement of virtual content displayed in response to the input can correspond to the spatial relationship between the virtual seat assigned to user 428 and other virtual content shared in the communication session. For example, the spatial arrangement of virtual content displayed in response to the input, and while user 428 is assigned to virtual seat 408, can be a first spatial arrangement. Additionally or alternatively, the spatial arrangement of virtual content displayed in response to detecting the input, and while user 428 is assigned to virtual seat 404, can be a second spatial arrangement, different from the first spatial arrangement. It is understood that the spatial arrangement can be an additional or alternative viewpoint (e.g., corresponding to virtual seat 411), and can assume any suitable arrangement that simulates any suitable virtual seating arrangement. As described above, it is understood that a virtual seating arrangement can include the quantity, position, orientation, spatial distribution, and/or spatial arrangement of virtual seats.

In some examples, virtual seat swapping is performed or forgone in accordance with a type of spatial template and/or virtual seating assignment. For example, as described with reference to FIGS. 3A-3N, a spatial template can include virtual content that is shared via the multi-user communication session, such as a virtual game board, a user interface for a media player, a virtual diorama, and/or the like. In some examples, the multi-user communication session and/or the shared virtual content can be configured to prevent virtual seat swapping, as illustrated in the top-down view of three-dimensional environment 402 in FIGS. 4F-4G.

From FIG. 4A to FIG. 4F, electronic device 101 detects movement of electronic device 101 to within threshold 418 of virtual seat 408. From FIG. 4A to FIG. 4F, virtual content 420 is shared via the multi-user communication session (e.g., and thus displayed in the three-dimensional environment 402). As described above, shared virtual content can be displayed at each electronic device in the multi-user communication session, and can be a two or three-dimensional virtual object that corresponds to (e.g., occupies) a location in a shared virtual space. The shared virtual content can therefore be interacted with (e.g., some or all of the electronic devices can modify content displayed in the shared virtual content), can be changed, and/or can be displayed at a position within the shared virtual space that is understood by each electronic device to be at least temporarily static (e.g., static relative to a virtual environment shared via the multi-user communication session).

In some examples, initiating display of the virtual content causes restrictions placed upon virtual seat swapping operations. For example, as shown from FIG. 4F to FIG. 4G, electronic device 101 can detect movement of the viewpoint of electronic device 101 within threshold 418 and/or maintaining of a location within threshold 418 for a period of time indicated by dwell timer 414. From FIG. 4F to FIG. 4G, in particular, electronic device 101 detects electronic device 101 remain within threshold 418 for a period of time greater than threshold 416, as indicated by dwell timer 414. In response to detecting the maintaining of the viewpoint within threshold 418, electronic device 101 can forgo reassignment of virtual seats. For example, as shown in FIG. 4G, electronic device 101 is assigned to virtual seat 404, and avatar 412 is assigned to virtual seat 408, as indicated by fill patterns occupying the virtual seats. Forgoing the exchanging of the virtual seats can improve the likelihood that users that correspond to specified seats (e.g., relating to the roles described with reference to FIGS. 3A-3N) can have particular perspectives of shared virtual content, such as ensuring a first team of game players are able to see a first side of a vertically oriented game board, and/or ensuring a second team of the game players are able to see a second side of the game board.

In some examples, electronic device 101 resolves competing requests to perform virtual seat swaps. For example, electronic device 101 and/or another electronic device can respectively detect inputs requesting a virtual seat swap targeting a target virtual seat. In some examples, the electronic device that provides the most recent input requesting the virtual seat swap can inherit the virtual seat. In some examples, the electronic device that provides the first input targeting the virtual seat over a period of time (e.g., 0.005, 0.01, 0.05, 0.1, 0.5, 1, or 1.5 seconds) can inherit the targeted virtual seat. In some examples, electronic device 101 can automatically assign a virtual seat after the competing virtual seat swaps are requested, thus using historical information related to virtual seat swap requests to facilitate virtual seat swapping.

For example, prior to the arrangement shown in FIG. 4H, electronic device 101 and/or the second electronic device corresponding to avatar 410 can respectively detect inputs directed toward virtual seat 408 and/or avatar 412 requesting a virtual seat swapping. To reduce the likelihood that users are rapidly assigned, then unassigned, from a virtual seat, the electronic devices can individually or communally determine which electronic device that targeted a virtual seat can be assigned to the virtual seat. As described above, electronic device 101 can be the electronic device that provided the most recent input (e.g., electronic device 101 detected an air pinch 0.5 seconds after the second electronic device detects an air pinch), or electronic device 101 can be the electronic device that provided the earliest input toward the virtual seat (e.g., electronic device 101 detected the air pinch 0.5 seconds before the second electronic device detects the air pinch). Dependent upon the example and/or a setting of the communication session, the most recent or the earliest provider of input can be determined as the inheritor of the targeted virtual set. For example, as shown in FIG. 4H, electronic device 101 can be the inheritor of the virtual seat, and avatar 410 can remain assigned to virtual seat 411.

From FIG. 4H to FIG. 4I, electronic device 101 detects movement of the viewpoint of electronic device 101 away from virtual seat 408 and/or beyond threshold 418. In FIG. 4I, electronic device 101 is not within threshold 422 of virtual seat 411. Accordingly, dwell timer 414 in FIG. 4I indicates the amount of time that electronic device 101 has cumulatively spent outside of threshold 418, and does not necessarily relate to the proximity of electronic device 101 relative to virtual seat 411. From FIG. 4I to FIG. 4J, electronic device 101 continues to move relative to three-dimensional environment 402, remaining outside of threshold 418 and threshold 422. Consequentially, from FIG. 4I to FIG. 4J, dwell timer 414 advances.

As described above, in some examples, electronic device 101 can cede a virtual seat to another electronic device automatically. For example, from FIG. 4J to FIG. 4K, dwell timer 414 exceeds threshold 416. In the example of FIG. 4K, virtual seat 411 can be reassigned to user 428, and virtual seat 408 can be reassigned to avatar 410, due to a setting for the multi-user communication session that dictates that virtual seats can be reassigned to the “loser” of competing virtual seat swapping requests. For example, in FIG. 4K, because electronic device 101 has moved and remained outside of threshold 418 for the period of time indicated by dwell timer 414 greater than threshold 416, electronic device 101 can reassign avatar 410 in accordance with its previous request described with reference to the input(s) that are detected prior to the example shown in FIG. 4H.

In some examples, electronic device 101 can cede a virtual seat to another electronic device without detecting an input expressly requesting virtual seat swapping. For example, the virtual seat swapping shown from FIG. 4J to FIG. 4K can be performed in response to detecting electronic device 101 move away from virtual seat 408, optionally independently of whether avatar 410 requested virtual seat swapping directed toward virtual seat 408. For example, electronic device 101 can determine that electronic device 101 has remained away from virtual seat 408 for a period of time greater than threshold 416, and can reassign the virtual seats in accordance with one or more rules, such as a rule that dictates a closest user to a particular virtual seat be assigned to that virtual seat. Additionally or alternatively, the rule can dictate that a user that last-interacted with the virtual seat (e.g., passed over the virtual seat, directed input toward the virtual seat, is within a portion of the environment such as a quadrant of a game room that corresponds to the virtual seat, and/or the like) be reassigned to the virtual seat.

In some examples, electronic device 101 reassigns and/or maintains virtual seating in response to detecting events such as users entering, exiting, and/or modifying the communication session. For example, from FIG. 4K to FIG. 4L, electronic device 101 detects an indication that the third user corresponding to avatar 412 exits the multi-user communication session. In some examples, a user can exit a multi-user communication session by selecting a button for exiting the session, powering off the device, and/or by answering an invitation to enter a different communication session. In response to detecting the indication, electronic device 101 can maintain the virtual seating arrangement with respect to virtual seats 411 and 408 (e.g., can forgo reassigning those virtual seats). In response to detecting the indication, electronic device 101 can update at least virtual seat 404, leaving virtual seat 404 vacant without assigning an updated user (e.g., because avatar 412 was assigned to virtual seat 404). In some examples, electronic device 101 can detect the indication that a user exits the communication session, and in response, can display a selectable option, such as a button or a graphic, that is selectable to display the virtual content with a spatial arrangement that corresponds to the spatial arrangement between the virtual seat assigned to electronic device 101 and the three-dimensional environment 402.

Thus, electronic device 101 can facilitate updating of a virtual seating arrangement and/or maintaining of a virtual seating arrangement when user(s) enter or exit the communication session. Although the operations described with reference to FIGS. 4A-4L are described with reference to operations primarily performed by specific electronic devices, it is understood that additional or alternative devices can perform the operations. For example, the operations described with reference to electronic device 101 can be performed by the second and/or the third electronic devices herein, and/or vice-versa.

It is understood that the examples shown and described herein are merely exemplary and that additional and/or alternative elements may be provided within the three-dimensional environment for initiating communication between users using portals. It should be understood that the appearance, shape, form, and size of each of the various user interface elements and objects shown and described herein are exemplary and that alternative appearances, shapes, forms and/or sizes may be provided. For example, the virtual objects representative of user interfaces (e.g., virtual object 316 and/or 340) may be provided in an alternative shape than a rectangular shape, such as a circular shape, triangular shape, etc. In some examples, the various selectable affordances (e.g., selectable options 362 and/or 364) described herein may be selected verbally via user verbal commands (e.g., “select option” or “select virtual object” verbal command). Additionally or alternatively, in some examples, the various options, user interface elements, control elements, etc. described herein may be selected and/or manipulated via user input received via one or more separate input devices in communication with the electronic device(s). For example, selection input may be received via physical input devices, such as a mouse, trackpad, keyboard, etc. in communication with the electronic device(s).

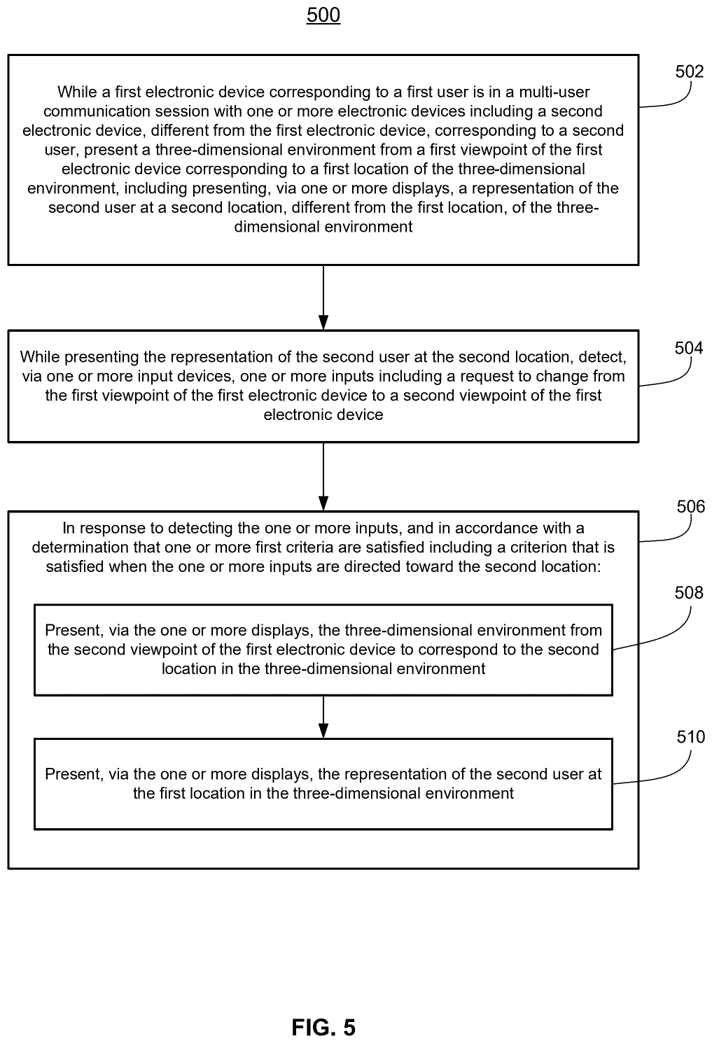

FIG. 5 illustrates a flow diagram illustrating an example process for updating a virtual seating assignment according to some examples of the disclosure. In some examples, process 500 begins at a first electronic device in communication with one or more displays and one or more input devices. In some examples, the first electronic device is optionally a head-mounted display similar or corresponding to electronic devices 260 and 270 of FIG. 2 and/or electronic device 101 of FIG. 1. As shown in FIG. 5, in some examples, at 502, while the first electronic device corresponding to a first user, such as user 328 as shown in FIG. 3A, is in a multi-user communication session with one or more electronic devices including a second electronic device, different from the first electronic device, corresponding to a second user, such as corresponding to avatar 308 as shown in FIG. 3A, the first electronic device presents a three-dimensional environment from a first viewpoint of the first electronic device corresponding to a first location of the three-dimensional environment, including presenting, via the one or more displays, a representation of the second user at a second location, different from the first location, of the three-dimensional environment, such as avatar 308 as shown in FIG. 3A.

In some examples, at 502, while presenting the representation of the second user at the second location, the first electronic device detects, via the one or more input devices, one or more inputs including a request to change from the first viewpoint of the first electronic device to a second viewpoint of the first electronic device, such as input performed by hand 322 in FIGS. 3A and/or 3B.

In some examples, at 506, in response to detecting the one or more inputs, and in accordance with a determination that one or more first criteria are satisfied including a criterion that is satisfied when the one or more inputs are directed toward the second location, at 508, the first electronic device presents, via the one or more displays, the three-dimensional environment from the second viewpoint of the first electronic device to correspond to the second location in the three-dimensional environment, such as the spatial arrangement of three-dimensional environment 302 as shown in FIGS. 3C and/or 3E.

In some examples, at 510, the first electronic device presents, via the one or more displays, the representation of the second user at the first location in the three-dimensional environment, such as avatar 308 as shown in FIG. 3C.

It is understood that process 500 is an example and that more, fewer, or different operations can be performed in the same or in a different order. Additionally, the operations in process 500 described above are, optionally, implemented by running one or more functional modules in an information processing apparatus such as general-purpose processors (e.g., as described with respect to FIG. 2) or application specific chips, and/or by other components of FIG. 2.

In some examples, wherein the second viewpoint includes a respective orientation relative to the three-dimensional environment. In some examples, in response to detecting the one or more inputs and in accordance with the determination that the one or more first criteria are satisfied: in accordance with a determination that a direction of a head of the first user is a first orientation relative to the three-dimensional environment when the one or more inputs are detected, the respective orientation relative to the three-dimensional environment is a second orientation, different from the first orientation relative to the three-dimensional environment. In some examples, the second location is associated with a virtual seat included in a virtual seating arrangement associated with the multi-user communication session, and in response to detecting the one or more inputs and in accordance with the determination that the one or more first criteria are satisfied: in accordance with a determination that an orientation associated the virtual seat is a first orientation relative to the three-dimensional environment, the second viewpoint relative to the three-dimensional environment includes a second orientation relative to the three-dimensional environment. In some examples, in response to detecting the one or more inputs and in accordance with the determination that the one or more first criteria are satisfied: in accordance with a determination that a respective viewpoint of the electronic device over a period of time prior to detecting the one or more inputs corresponds to a first orientation relative to the three-dimensional environment, the second viewpoint relative to the three-dimensional environment includes a second orientation relative to the three-dimensional environment, and in accordance with a determination that the respective viewpoint over the period of time prior to detecting the one or more inputs corresponds to a third orientation relative to the three-dimensional environment, the second viewpoint relative to the three-dimensional environment includes a fourth orientation relative to the three-dimensional environment.

In some examples, wherein, while the first electronic device is in the multi-user communication session, the three-dimensional environment further includes a representation of a third user corresponding to a third electronic device at a third location, different from the second location, the process 500 further comprises in response to detecting the one or more inputs, and in accordance with a determination that the one or more inputs are directed toward the third location: presenting, via the one or more displays, the three-dimensional environment from a third viewpoint of the first electronic device that corresponds to the third location in the three-dimensional environment; and presenting, via the one or more displays, the representation of the third user at the first location in the three-dimensional environment. In some examples, displaying the representation of the second user at the first location in the three-dimensional environment comprises in accordance with a determination that an orientation of the representation of the second user relative to the three-dimensional environment when the one or more inputs are detected is a first orientation, displaying the representation of the second user with a second orientation relative to the three-dimensional environment. In some examples, wherein the one or more inputs are different from movement of a body of the first user of the first electronic device relative to the three-dimensional environment. In some examples, when the one or more inputs are detected: virtual content including the representation of the second user has a spatial arrangement relative to the first viewpoint of the first electronic device that is a first spatial arrangement when the one or more inputs are detected, and respective virtual content that is included in the virtual content, including the representation of the second user, has a second spatial arrangement relative to each other, and in some examples, the process 500 further comprises: while displaying the representation of the second user at the second location, detecting, via the one or more input devices, a second input, different from the one or more inputs, including a request to change the spatial arrangement from the first spatial arrangement to a third spatial arrangement while maintaining a viewpoint of the first electronic device as the first viewpoint relative to the three-dimensional environment; and in response to detecting the second input, changing the spatial arrangement between the virtual content and a viewpoint of the first electronic device to be the third spatial arrangement; and maintaining the spatial arrangement between the respective virtual content as the second spatial arrangement. In some examples, process 500 further comprises, in response to detecting the one or more inputs, and in accordance with the determination that the one or more first criteria are satisfied, displaying, via the one or more displays, visual feedback indicating the change of viewpoint of the first electronic device from corresponding to the first location to corresponding to the second location. In some examples, the one or more inputs directed toward the second location include a selection input directed toward a respective representation corresponding to a respective user of the multi-user communication session, and process 500 further comprises: in response to detecting the selection input, and in accordance with a determination that one or more second criteria are satisfied, displaying, via the one or more displays, one or more visual indications associated with a virtual seating arrangement associated with the multi-user communication session. In some examples, wherein the respective representation corresponds to the representation of the second user, the one or more visual indications include a first visual indication corresponding to the second user, and while a location of the representation of the second user corresponds to the second location, the first visual indication is displayed at the second location, process 500 further comprises, in response to detecting an indication of movement of the first user from corresponding to the second location to corresponding to a third location, different from the second location, moving the first visual indication from the second location to the third location in the three-dimensional environment. In some examples, wherein the second location is different from a third location that corresponds to a virtual seat included in the virtual seating arrangement, and wherein the virtual seat is assigned to the second user when the one or more inputs are detected. In some examples, wherein the one or more first criteria include a criterion that is satisfied when a configuration associated with the multi-user communication session is a first configuration, process 500 further comprises, in response to detecting the one or more inputs, in accordance with a determination that the one or more first criteria are not satisfied, and that the request to change the location corresponding to the first viewpoint is associated with a virtual seat associated with the second user: updating a viewpoint of the first electronic device to correspond to a third location that corresponds to the virtual seat in the three-dimensional environment; and displaying, via the one or more displays, the representation of the second user at the first location in the three-dimensional environment. In some examples, wherein the one or more second criteria include a criterion that is satisfied when a virtual seat that corresponds to the second user is a first type of virtual seat, process 500 further comprises, in response to detecting the selection input, and in accordance with a determination that the one or more second criteria are not satisfied, forgoing displaying of the one or more visual indications. In some examples, when the one or more inputs are detected, the three-dimensional environment includes virtual content that has a first spatial arrangement relative to the three-dimensional environment, and the virtual content and the first viewpoint of the first electronic device have a second spatial arrangement, different from the first spatial arrangement, within the three-dimensional environment, wherein the virtual content includes the representation of the second user, and in some examples, the process 500 further comprises: in response to detecting the one or more inputs: changing a spatial arrangement between the virtual content and the first viewpoint of the first electronic device to be a third spatial arrangement, different from the second spatial arrangement, relative to the first viewpoint of the first electronic device, and maintaining the first spatial arrangement between the virtual content relative to the three-dimensional environment. In some examples, wherein the second location is associated with a virtual seat included in a virtual seating arrangement shared via the multi-user communication session, process 500 further comprises, while the first electronic device is in the multi-user communication session, and while the first viewpoint of the first electronic device is the first viewpoint, detecting, via the one or more inputs devices, a request to change virtual seats with the second user from the second electronic device; and in response to detecting the request from the second electronic device, initiating a process to exchange the virtual seats with the second user, wherein the process includes displaying a prompt to approve the exchanging of the virtual seats. In some examples, process 500 further comprises while displaying the prompt in response to detecting the request from the second electronic device, detecting, via the one or more input devices, input directed to the prompt; and, in response to detecting the input: in accordance with a determination the input indicates approval of the exchanging the virtual seats: presenting, via the one or more displays, the three-dimensional environment from the second viewpoint of the first electronic device such that the second viewpoint corresponds to the second location in the three-dimensional environment; and presenting, via the one or more displays, the representation of the second user at the first location in the three-dimensional environment; and in accordance with a determination the input indicates rejection of the exchanging the virtual seats: forgoing the presenting of the first electronic device from the second viewpoint to correspond to the second location in the three-dimensional environment; and forgoing presenting of the representation of the second user at the first location in the three-dimensional environment.

In some examples, the second location is associated with a virtual seat included in a virtual seating arrangement of the multi-user communication session, the one or more inputs include a request to exchange a virtual seat with the second user, and the one or more first criteria include a criterion that is satisfied when the one or more inputs are detected after one or more other requests communicated from other electronic devices in the multi-user communication session requesting the exchanging of the virtual seat with the first user are detected. In some examples, wherein the one or more first criteria include a criterion that is satisfied when the three-dimensional environment includes shared virtual content that is shared via the multi-user communication session, wherein the shared virtual content is different from a respective representation of a user in the multi-user communication session.

In some examples, process 500 further comprises, in response to detecting the one or more inputs, in accordance with a determination that the one or more first criteria are satisfied, and in accordance with a determination that a role of the first user associated with the multi-user communication session is a first role, changing a role of the first user of the first electronic device from being to be the first role, and changing the role of the first user to be a second role. In some examples, process 500 further comprises, while the first electronic device is in the multi-user communication session, displaying, via the one or more displays, virtual content, wherein the virtual content and a physical environment included in the three-dimensional environment have a first spatial arrangement, and the virtual content and the first viewpoint of the first electronic device have a second spatial arrangement, different from the first spatial arrangement; and in response to detecting the one or more inputs, and in accordance with the determination that the one or more first criteria are satisfied: in accordance with a determination that the virtual content is world locked in the physical environment: maintaining the first spatial arrangement; and changing the second spatial arrangement to a third spatial arrangement, different from the second spatial arrangement; and in accordance with a determination that the virtual content is not world locked in the physical environment: changing the first spatial arrangement to a fourth spatial arrangement, different from the first spatial arrangement; and changing the second spatial arrangement to the third spatial arrangement.

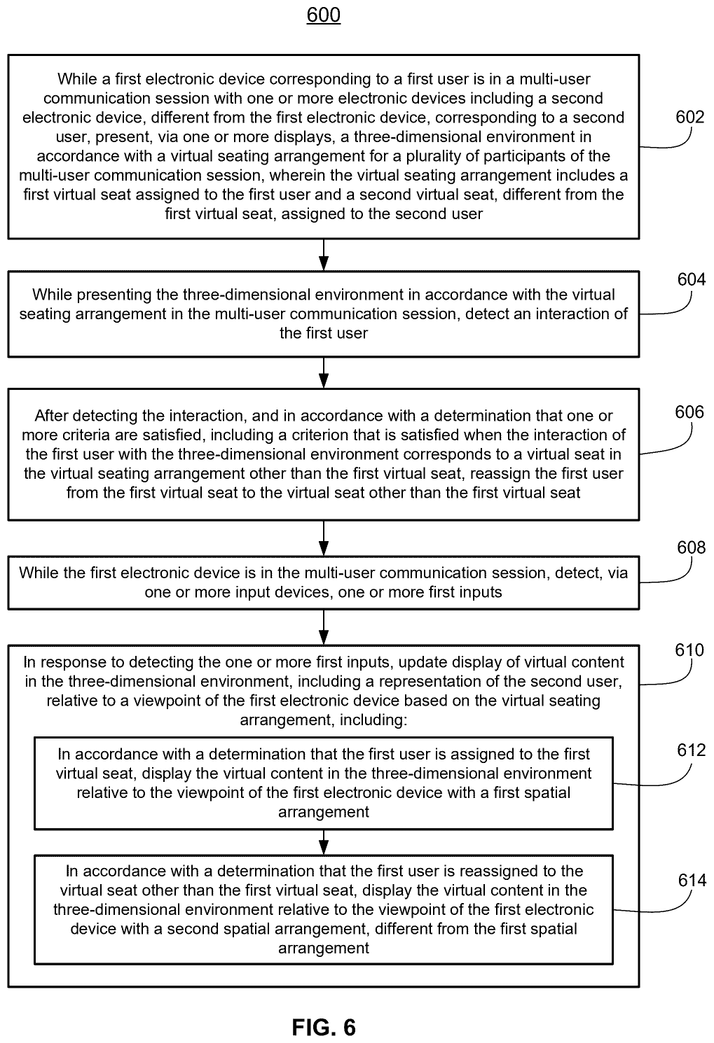

FIG. 6 illustrates a flow diagram illustrating an example process for reassigning virtual seats according to some examples of the disclosure. In some examples, process 600 begins at a first electronic device in communication with one or more displays and one or more input devices. In some examples, the first electronic device is optionally a head-mounted display similar or corresponding to electronic devices 260 and 270 of FIG. 2 and/or electronic device 101 of FIG. 1. As shown in FIG. 6, in some examples, at 602, while the first electronic device, such as electronic device 101, corresponding to a first user is in a multi-user communication session with one or more electronic devices including a second electronic device, different from the first electronic device, corresponding to a second user, the first electronic device presents, via the one or more displays, a three-dimensional environment, such as three-dimensional environment 402 as shown in FIG. 4A, in accordance with a virtual seating arrangement for a plurality of participants of the multi-user communication session, wherein the virtual seating arrangement includes a first virtual seat assigned to the first user, such as virtual seat 404 as shown in FIG. 4A, and a second virtual seat, different from the first virtual seat, assigned to the second user, such as virtual seat 408 assigned to avatar 412 as shown in FIG. 4A.

In some examples, at 604, while presenting the three-dimensional environment in accordance with the virtual seating arrangement in the multi-user communication session, the first electronic device detects an interaction of the first user, such as movement of user 428 from as shown in FIG. 4A to FIG. 4B, and/or the maintaining of the location of user 428 from as shown in FIG. 4D to 4E.

In some examples, at 606, after detecting the interaction, and in accordance with a determination that one or more criteria are satisfied, including a criterion that is satisfied when the interaction of the first user with the three-dimensional environment corresponds to a virtual seat in the virtual seating arrangement other than the first virtual seat, the first electronic device reassigns the first user from the first virtual seat to the virtual seat other than the first virtual seat, such as the reassigning of virtual seat 408 from FIG. 4D to FIG. 4E.

In some examples, at 608, while the first electronic device is in the multi-user communication session, the first electronic device detects, via the one or more input devices, one or more first inputs, such as a recentering and/or a recalling of users in the multi-user communication session to respective virtual seats, such as an input that when detected causes electronic device 101 to present the spatial arrangement of users and/or virtual seats shown in FIG. 4A.

In some examples, at 610, in response to detecting the one or more first inputs, the first electronic device updates display of virtual content in the three-dimensional environment, including a representation of the second user, relative to a viewpoint of the first electronic device based on the virtual seating arrangement, including, at 612, in accordance with a determination that the first user is assigned to the first virtual seat, displaying the virtual content in the three-dimensional environment relative to the viewpoint of the first electronic device with a first spatial arrangement, such as an input that when detected causes electronic device 101 to present the spatial arrangement of users and/or virtual seats shown in FIG. 4A.

In some examples, at 614, in accordance with a determination that the first user is reassigned to the virtual seat other than the first virtual seat, the first electronic device displays the virtual content in the three-dimensional environment relative to the viewpoint of the first electronic device with a second spatial arrangement, different from the first spatial arrangement, such as a spatial arrangement of virtual seats 408 and 411 relative to first virtual seat 404 as shown in FIG. 4A or the spatial arrangement of virtual seats 404 and 411 relative to virtual seat 408 as shown in FIG. 4H.

It is understood that process 600 is an example and that more, fewer, or different operations can be performed in the same or in a different order. Additionally, the operations in process 600 described above are, optionally, implemented by running one or more functional modules in an information processing apparatus such as general-purpose processors (e.g., as described with respect to FIG. 2) or application specific chips, and/or by other components of FIG. 2.

In some examples, the one or more criteria are not satisfied when the interaction is an input requesting assigning of the virtual seat other than the first virtual seat the first virtual seat of the first user. In some examples, the interaction includes an input request assigning of the virtual seat other than the first virtual seat to the first user, process 600 further comprises in response to detecting the input requesting assigning of the virtual seat other than the first virtual seat to the first user, in accordance with a determination that the second electronic device requests assigning of the virtual seat other than the first virtual seat at a time prior to detecting the input and the time is within a threshold amount of time of detecting the input, forgoing the assigning of the virtual seat other than the first virtual seat to the first user. In some examples, the criterion is satisfied when the interaction includes movement of the viewpoint beyond a threshold distance of a location corresponding to the first virtual seat in the three-dimensional environment. In some examples, the criterion is satisfied when the interaction includes movement of the viewpoint to within a threshold distance of a location corresponding to the virtual seat in the virtual seating arrangement other than the first virtual seat, in the three-dimensional environment. In some examples, the interaction includes movement of the viewpoint away from a location corresponding to the first virtual seat in the three-dimensional environment, and the one or more criteria include a criterion satisfied when the viewpoint of the first electronic device is away from the location for a period of time greater than a threshold amount of time. In some examples, the one or more criteria include a criterion that is satisfied when a type of the virtual seating arrangement corresponds to a first type of seating arrangement associated with interacting with a virtual object shared in the multi-user communication session. In some examples, process 600 further comprises while presenting the three-dimensional environment in accordance with the virtual seating arrangement in the multi-user communication session, and while the first virtual seat is assigned to the first user, and while the second virtual seat that is assigned to the second user: in accordance with the determination that one or more respective criteria are satisfied, including a criterion that is satisfied when the interaction with the three-dimensional environment provided by the first user corresponds to a respective virtual seat, different from the virtual seat other than the first virtual seat, and different from the first virtual seat, reassigning the first user from the first virtual seat to the respective virtual seat. In some examples, the one or more criteria are not satisfied when the virtual seat other than the first virtual seat is assigned to a respective user, different from the first user. In some examples, the one or more criteria include a criterion that is satisfied when the virtual seat other than the first virtual seat ceases being assigned to a respective user of a respective electronic device, different from the first user, at a time that is within a threshold period of time that the interaction with the three-dimensional environment is detected. In some examples, process 600 further comprises while the first user is assigned to the first virtual seat, receiving an indication that the second electronic device exits the multi-user communication session; and in response to receiving the indication, forgoing reassigning of the first virtual seat from the first virtual seat to a respective virtual seat, different from the first virtual seat. In some examples, process 600 further comprises in response to receiving the indication that the second electronic device exits the multi-user communication session, displaying, via the one or more one or more displays, a selectable option that is selectable to display the virtual content with the first spatial arrangement relative to the viewpoint of the first electronic device.

Some examples of the disclosure are directed to an electronic device, comprising: one or more processors; memory; and one or more programs stored in the memory and configured to be executed by the one or more processors, the one or more programs including instructions for performing any of the above methods.

Some examples of the disclosure are directed to a non-transitory computer readable storage medium storing one or more programs, the one or more programs comprising instructions, which when executed by one or more processors of an electronic device, cause the electronic device to perform any of the above methods.

Some examples of the disclosure are directed to an electronic device, comprising one or more processors, memory, and means for performing any of the above methods.

Some examples of the disclosure are directed to an information processing apparatus for use in an electronic device, the information processing apparatus comprising means for performing any of the above methods.

The foregoing description, for purpose of explanation, has been described with reference to specific examples. However, the illustrative discussions above are not intended to be exhaustive or to limit the disclosure to the precise forms disclosed. Many modifications and variations are possible in view of the above teachings. The examples were chosen and described in order to best explain the principles of the disclosure and its practical applications, to thereby enable others skilled in the art to best use the disclosure and various described examples with various modifications as are suited to the particular use contemplated.

What is claimed is:

1. A method comprising:
at a first electronic device in communication with one or more input devices and one or more displays:
while the first electronic device corresponding to a first user is in a multi-user communication session with one or more electronic devices including a second electronic device, different from the first electronic device, corresponding to a second user, presenting a three-dimensional environment from a first viewpoint of the first electronic device corresponding to a first location of the three-dimensional environment, including presenting, via the one or more displays, a representation of the second user at a second location, different from the first location, of the three-dimensional environment; and
while presenting the representation of the second user at the second location, detecting, via the one or more input devices, one or more inputs including a request to change from the first viewpoint of the first electronic device to a second viewpoint of the first electronic device; and
in response to detecting the one or more inputs, and in accordance with a determination that one or more first criteria are satisfied including a criterion that is satisfied when the one or more inputs are directed toward the second location:
presenting, via the one or more displays, the three-dimensional environment from the second viewpoint of the first electronic device such that the second viewpoint corresponds to the second location in the three-dimensional environment; and
presenting, via the one or more displays, the representation of the second user at the first location in the three-dimensional environment.

2. The method of claim 1, wherein, while the first electronic device is in the multi-user communication session, the three-dimensional environment further includes a representation of a third user corresponding to a third electronic device at a third location, different from the second location, the method further comprising:
in response to detecting the one or more inputs, and in accordance with a determination that the one or more inputs are directed toward the third location:
presenting, via the one or more displays, the three-dimensional environment from a third viewpoint of the first electronic device that corresponds to the third location in the three-dimensional environment; and
presenting, via the one or more displays, the representation of the third user at the first location in the three-dimensional environment.

3. The method of claim 1, wherein displaying the representation of the second user at the first location in the three-dimensional environment comprises:
in accordance with a determination that an orientation of the representation of the second user relative to the three-dimensional environment when the one or more inputs are detected is a first orientation, displaying the representation of the second user with a second orientation relative to the three-dimensional environment.

4. The method of claim 1, further comprising:
in response to detecting the one or more inputs, and in accordance with the determination that the one or more first criteria are satisfied, displaying, via the one or more displays, visual feedback indicating the change of viewpoint of the first electronic device from corresponding to the first location to corresponding to the second location.

5. The method of claim 1, wherein the one or more inputs directed toward the second location include a selection input directed toward a respective representation corresponding to a respective user of the multi-user communication session, the method further comprising:
in response to detecting the selection input, and in accordance with a determination that one or more second criteria are satisfied, displaying, via the one or more displays, one or more visual indications associated with a virtual seating arrangement associated with the multi-user communication session.

6. The method of claim 1, wherein:
when the one or more inputs are detected, the three-dimensional environment includes virtual content that has a first spatial arrangement relative to the three-dimensional environment, and the virtual content and the first viewpoint of the first electronic device have a second spatial arrangement, different from the first spatial arrangement, within the three-dimensional environment, wherein the virtual content includes the representation of the second user, and
the method further comprises:
in response to detecting the one or more inputs:
changing a spatial arrangement between the virtual content and the first viewpoint of the first electronic device to be a third spatial arrangement, different from the second spatial arrangement, relative to the first viewpoint of the first electronic device, and
maintaining the first spatial arrangement between the virtual content relative to the three-dimensional environment.

7. The method of claim 1, wherein the second location is associated with a virtual seat included in a virtual seating arrangement shared via the multi-user communication session, the method further comprising:
while the first electronic device is in the multi-user communication session, and while the first viewpoint of the first electronic device is the first viewpoint, detecting, via the one or more inputs devices, a request to exchange virtual seats with the second user from the second electronic device; and
in response to detecting the request from the second electronic device, initiating a process to exchange virtual seats with the second user, wherein the process includes displaying a prompt to approve the exchanging of virtual seats.

8. The method of claim 1, wherein:
the second location is associated with a virtual seat included in a virtual seating arrangement of the multi-user communication session,
the one or more inputs include a request to exchange a virtual seat with the second user, and
the one or more first criteria include a criterion that is satisfied when the one or more inputs are detected after one or more other requests communicated from other electronic devices in the multi-user communication session requesting the exchanging of the virtual seat with the first user are detected.

9. The method of claim 1, wherein the one or more first criteria include a criterion that is satisfied when the three-dimensional environment includes shared virtual content that is shared via the multi-user communication session, wherein the shared virtual content is different from a respective representation of a user in the multi-user communication session.

10. The method of claim 1, further comprising:
in response to detecting the one or more inputs, in accordance with a determination that the one or more first criteria are satisfied, and in accordance with a determination that a role of the first user associated with the multi-user communication session is a first role, changing a role of the first user of the first electronic device from being to be the first role, and changing the role of the first user to be a second role.

11. A first electronic device that is in communication with one or more input devices and one or more displays, the first electronic device comprising:
one or more processors;
memory; and
one or more programs stored in the memory and configured to be executed by the one or more processors, the one or more programs including instructions for performing a method comprising:
while the first electronic device corresponding to a first user is in a multi-user communication session with one or more electronic devices including a second electronic device, different from the first electronic device, corresponding to a second user, presenting a three-dimensional environment from a first viewpoint of the first electronic device corresponding to a first location of the three-dimensional environment, including presenting, via the one or more displays, a representation of the second user at a second location, different from the first location, of the three-dimensional environment; and
while presenting the representation of the second user at the second location, detecting, via the one or more input devices, one or more inputs including a request to change from the first viewpoint of the first electronic device to a second viewpoint of the first electronic device; and
in response to detecting the one or more inputs, and in accordance with a determination that one or more first criteria are satisfied including a criterion that is satisfied when the one or more inputs are directed toward the second location:
presenting, via the one or more displays, the three-dimensional environment from the second viewpoint of the first electronic device such that the second viewpoint corresponds to the second location in the three-dimensional environment; and
presenting, via the one or more displays, the representation of the second user at the first location in the three-dimensional environment.

12. A non-transitory computer readable storage medium storing one or more programs, the one or more programs comprising instructions, which when executed by one or more processors of a first electronic device that is in communication with one or more input devices and one or more displays, cause the first electronic device to perform a method comprising:
while the first electronic device corresponding to a first user is in a multi-user communication session with one or more electronic devices including a second electronic device, different from the first electronic device, corresponding to a second user, presenting a three-dimensional environment from a first viewpoint of the first electronic device corresponding to a first location of the three-dimensional environment, including presenting, via the one or more displays, a representation of the second user at a second location, different from the first location, of the three-dimensional environment; and
while presenting the representation of the second user at the second location, detecting, via the one or more input devices, one or more inputs including a request to change from the first viewpoint of the first electronic device to a second viewpoint of the first electronic device; and
in response to detecting the one or more inputs, and in accordance with a determination that one or more first criteria are satisfied including a criterion that is satisfied when the one or more inputs are directed toward the second location:
presenting, via the one or more displays, the three-dimensional environment from the second viewpoint of the first electronic device such that the second viewpoint corresponds to the second location in the three-dimensional environment; and
presenting, via the one or more displays, the representation of the second user at the first location in the three-dimensional environment.

13. The first electronic device of claim 11, wherein, while the first electronic device is in the multi-user communication session, the three-dimensional environment further includes a representation of a third user corresponding to a third electronic device at a third location, different from the second location, and the method further comprises:
in response to detecting the one or more inputs, and in accordance with a determination that the one or more inputs are directed toward the third location:
presenting, via the one or more displays, the three-dimensional environment from a third viewpoint of the first electronic device that corresponds to the third location in the three-dimensional environment; and
presenting, via the one or more displays, the representation of the third user at the first location in the three-dimensional environment.

14. The first electronic device of claim 11, wherein the method further comprises:
in response to detecting the one or more inputs, and in accordance with the determination that the one or more first criteria are satisfied, displaying, via the one or more displays, visual feedback indicating the change of viewpoint of the first electronic device from corresponding to the first location to corresponding to the second location.

15. The first electronic device of claim 11, wherein the one or more inputs directed toward the second location include a selection input directed toward a respective representation corresponding to a respective user of the multi-user communication session, and the method further comprises:
in response to detecting the selection input, and in accordance with a determination that one or more second criteria are satisfied, displaying, via the one or more displays, one or more visual indications associated with a virtual seating arrangement associated with the multi-user communication session.

16. The first electronic device of claim 11, wherein the second location is associated with a virtual seat included in a virtual seating arrangement shared via the multi-user communication session, the method further comprising:
while the first electronic device is in the multi-user communication session, and while the first viewpoint of the first electronic device is the first viewpoint, detecting, via the one or more inputs devices, a request to exchange virtual seats with the second user from the second electronic device; and
in response to detecting the request from the second electronic device, initiating a process to exchange virtual seats with the second user, wherein the process includes displaying a prompt to approve the exchanging of virtual seats.

17. The non-transitory computer readable storage medium of claim 12, wherein, while the first electronic device is in the multi-user communication session, the three-dimensional environment further includes a representation of a third user corresponding to a third electronic device at a third location, different from the second location, and the method further comprises:
in response to detecting the one or more inputs, and in accordance with a determination that the one or more inputs are directed toward the third location:
presenting, via the one or more displays, the three-dimensional environment from a third viewpoint of the first electronic device that corresponds to the third location in the three-dimensional environment; and
presenting, via the one or more displays, the representation of the third user at the first location in the three-dimensional environment.

18. The non-transitory computer readable storage medium of claim 12, wherein the method further comprises:
in response to detecting the one or more inputs, and in accordance with the determination that the one or more first criteria are satisfied, displaying, via the one or more displays, visual feedback indicating the change of viewpoint of the first electronic device from corresponding to the first location to corresponding to the second location.

19. The non-transitory computer readable storage medium of claim 12, wherein the one or more inputs directed toward the second location include a selection input directed toward a respective representation corresponding to a respective user of the multi-user communication session, and the method further comprises:
in response to detecting the selection input, and in accordance with a determination that one or more second criteria are satisfied, displaying, via the one or more displays, one or more visual indications associated with a virtual seating arrangement associated with the multi-user communication session.

20. The non-transitory computer readable storage medium of claim 12, wherein the second location is associated with a virtual seat included in a virtual seating arrangement shared via the multi-user communication session, the method further comprising:
while the first electronic device is in the multi-user communication session, and while the first viewpoint of the first electronic device is the first viewpoint, detecting, via the one or more inputs devices, a request to exchange virtual seats with the second user from the second electronic device; and
in response to detecting the request from the second electronic device, initiating a process to exchange virtual seats with the second user, wherein the process includes displaying a prompt to approve the exchanging of virtual seats.
